(19) United States
(12) Patent Application Publication
(10) Pub. No.: US 2026/0270733 A1
(43) Pub. Date: Sep. 10, 2026

(54) COEFFICIENT QUANTIZATION FOR CSI REPORT

(71) Applicant: Lenovo (Singapore) Pte. Ltd., Singapore (SG)

(72) Inventors: Ahmed Hindy, Aurora, IL (US); Vijay Nangia, Woodridge, IL (US)

(21) Appl. No.: 18/873,283

(22) PCT Filed: Jun. 7, 2023
(86) PCT No.: PCT/IB2023/055898

§ 371 Date: Dec. 9, 2024

Related U.S. Application Data
(60) Provisional application No. 63/349,962, filed on Jun. 7, 2022.

(51) Int. Cl. H04W 24/08; H04L 5/00

(52) U.S. Cl. CPC H04W 24/08; H04L 5/0051

(57) ABSTRACT

Apparatuses, methods, and systems are disclosed for coefficient quantization for CSI feedback under CJT. One method includes receiving a CSI reporting setting associated with a CMR, the CMR corresponding to at least two CSI-RS segments, where the at least two CSI-RS segments correspond to at least two PMI segments. The method includes receiving a set of CSI-RS on the CMR. The method includes generating at least two sets of coefficients based on the at least two CSI-RS segments by quantizing a first set of coefficients corresponding to a first of the at least two PMI segments according to a first quantization scheme and quantizing a second set of coefficients corresponding to a second of the at least two PMI segments according to a second quantization scheme. The method includes transmitting a CSI report comprising the at least two PMI segments.

### FIELD

The subject matter disclosed herein relates generally to wireless communications and more particularly relates to coefficient quantization for Channel State Information (“CSI”) feedback, e.g., under coherent joint transmission (“CJT”).

### BACKGROUND

A wireless communications system may include one or multiple network communication devices, such as base stations, which may be otherwise known as an evolved NodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (“3G”) Radio Access Technology (“RAT”), fourth generation (“4G”) RAT, fifth generation (“5G”) RAT, among other suitable RATs beyond 5G (e.g., sixth generation (“6G”)).

In certain wireless communications networks, multiple transmission and reception points may be used. In such networks, CSI reference signals (“CSI-RS”) may be transmitted by the multiple Transmission-Reception Points (“TRPs”).

### BRIEF SUMMARY

Disclosed are solutions for coefficient quantization for CSI feedback under CJT. Said solutions may be implemented by apparatus, systems, methods, and/or computer program products.

One method at a UE includes receiving a CSI Reporting Setting that is associated with channel measurement resource (“CMR”) corresponding to at least two CSI-RS segments, where the at least two CSI-RS segments correspond to at least two Precoder Matrix Indicator (“PMI”) segments. The method includes receiving a set of CSI-RS on the CMR and generating at least two sets of coefficients based on the at least two CSI-RS segments. Here, each PMI segment comprises a set of coefficients, each coefficient associated with at least one of a quantized amplitude value and a quantized phase value according to one of at least two quantization schemes. A first set of coefficients corresponding to a first of the at least two PMI segments is quantized according to a first of the at least two quantization schemes and a second set of coefficients corresponding to a second of the at least two PMI segments is quantized according to a second of the at least two quantization schemes. The method includes transmitting a CSI report comprising the at least two PMI segments.

One method at a network node (e.g., a Radio Access Network entity) includes transmitting transmit, to a UE, a CSI reporting setting that is associated with a CMR corresponding to at least two CSI-RS segments, where the at least two CSI-RS segments correspond to at least two PMI segments. The method includes transmitting a set of CSI-RS and receiving a CSI report containing the at least two PMI segments, wherein each PMI segment contains a set of coefficients based on a corresponding CSI-RS segment, each coefficient associated with at least one of a quantized amplitude value and a quantized phase value according to one of at least two quantization schemes. A first of the at least two PMI segments corresponds to a first set of coefficients that is quantized according to a first of the at least two quantization schemes and a second of the at least two PMI segments corresponds to a second set of coefficients that is quantized according to a second of the at least two quantization schemes.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 illustrates an example of a wireless communication system that supports techniques for coefficient quantization for CSI feedback under CJT in accordance with aspects of the present disclosure;

FIG. 2 illustrates an example of a Third Generation Partnership Project (“3GPP”) New Radio (“NR”) protocol stack that supports different protocol layers in the UE and network in accordance with aspects of the present disclosure;

FIG. 3 illustrates an example of a UE served by multiple panels in a coordination cluster connected to a central unit in accordance with aspects of the present disclosure;

FIG. 4 illustrates an example of a UE apparatus that supports techniques for coefficient quantization for CSI feedback under CJT in accordance with aspects of the present disclosure;

FIG. 5 illustrates an example of a network equipment (“NE”) apparatus that supports techniques for coefficient quantization for CSI feedback under CJT in accordance with aspects of the present disclosure;

FIG. 6 illustrates a flowchart diagram of a first method that supports techniques for coefficient quantization for CSI feedback under CJT in accordance with aspects of the present disclosure; and

FIG. 7 illustrates a flowchart of a second method that supports techniques for coefficient quantization for CSI feedback under CJT in accordance with aspects of the present disclosure.

### DETAILED DESCRIPTION

Disclosed herein are systems, methods, and apparatuses for quantizing inter-TRP co-phasing coefficients (also referred to as “phase-coupling” coefficients) for CJT. Here, the co-phasing coefficients are reported in CSI feedback. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

For CSI reporting in 3GPP NR Release 16 specification (“Rel-16”), two types of codebooks are defined. The NR Type-I codebook uses multiple predefined matrices from which a selection is made by UE report and/or Radio Resource Control (“RRC”) Configuration. In contrast, the NR Type-II codebook is not based on a predefined table, but it is based on a specifically designed mathematical formula with a several parameters. The parameters in the formula are determined by RRC Configuration and/or UE report. The NR Type-II codebook is based on a more detailed CSI report and supports Multi-User Multiple-Input, Multiple-Output (“MU-MIMO”) communication.

For 3GPP NR, within a cell, multiple panel nodes (e.g., multiple TRP and/or multiple Remote Radio Head (“RRH”) nodes) may communicate simultaneously with one UE to enhance coverage, throughput, and/or reliability. The panels (or TRPs/RRHs) may not be co-located, i.e., they may be placed in remote locations. Communicating with the same UE via multiple nodes comes at the expense of excessive control signaling between the network side and the UE side, so as to communicate the best transmission configuration, e.g., whether to support multi-point transmission, and if so, which panel would operate simultaneously, in addition to a possibly super-linear increase in the amount of CSI feedback reported from the UE to the network, since a distinct codebook may be needed for each point.

Aspects of the present disclosure are described in the context of a wireless communications system. Aspects of the present disclosure are further illustrated and described with reference to system diagrams, device diagrams, configuration parameter diagrams, and/or flowcharts.

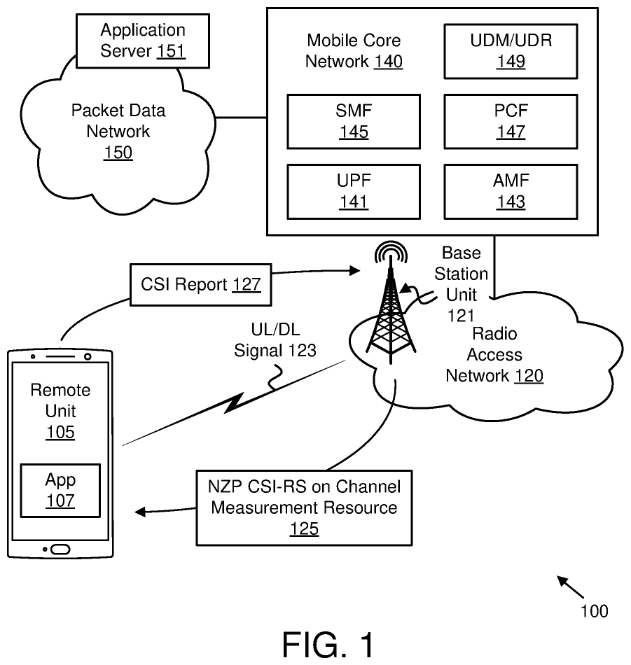

FIG. 1 illustrates an example of a wireless communication system 100 supporting techniques for coefficient quantization for CSI feedback under CJT, in accordance with aspects of the present disclosure. The wireless communications system 100 may support various radio access technologies. In some implementations, the wireless communications system 100 may be a 4G network, such as a Long-Term Evolution (“LTE”) network or an LTE-Advanced (“LTE-A”) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (“IEEE”) 802.11 (i.e., Wi-Fi), IEEE 802.16 (i.e., WiMAX), IEEE 802.20. The wireless communications system 100 may support radio access technologies beyond 5G. Additionally, the wireless communications system 100 may support technologies, such as time division multiple access (“TDMA”), frequency division multiple access (“FDMA”), or code division multiple access (“CDMA”), etc.

In one embodiment, the wireless communication system 100 includes at least one remote unit 105, a RAN 120, and a mobile core network 140. The RAN 120 and the mobile core network 140 form a mobile communication network. The RAN 120 may be composed of at least one base station unit 121 with which the remote unit 105 communicates using wireless communication links 123. Even though a specific number of remote units 105, RANs 120, base station units 121, wireless communication links 123, and mobile core networks 140 are depicted in FIG. 1, one of skill in the art will recognize that any number of remote units 105, RANs 120, base station units 121, wireless communication links 123, and mobile core networks 140 may be included in the wireless communication system 100.

In one implementation, the RAN 120 is compliant with the Fifth Generation (“5G”) cellular system specified in the Third Generation Partnership Project (“3GPP”) specifications. For example, the RAN 120 may be a Next Generation Radio Access Network (“NG-RAN”), implementing NR Radio Access Technology (“RAT”) and/or LTE RAT. In another example, the RAN 120 may include non-3GPP RAT (e.g., Wi-Fi® or IEEE 802.11-family compliant wireless local area network (“WLAN”)). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base station units 121 in the RAN 120 via uplink (“UL”) and downlink (“DL”) communication signals. Furthermore, the UL and DL communication signals may be carried over the wireless communication links 123. Furthermore, the UL communication signals may comprise one or more UL channels, such as the Physical Uplink Control Channel (“PUCCH”) and/or Physical Uplink Shared Channel (“PUSCH”), while the DL communication signals may comprise one or more DL channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In various embodiments, the remote unit 105 receives a CSI reporting configuration 125 from the base station unit 121. As described in greater detail below, the CSI reporting configuration 125 may configure the remote unit 105 to include a CSI reporting setting that is associated with a CMR corresponding to at least two CSI-RS segments, wherein the at least two CSI-RS segments correspond to at least two PMI segments. In various embodiments, there is a one-to-one mapping of CSI-RS segment to PMI segment.

Moreover, after receiving a set of channel measurement reference signals (including at least one non-zero power (“NZP”) CSI-RS) from multiple network nodes (e.g., multiple base station units 121, or multiple TRP/RRH nodes associated with the same base station unit 121), the remote unit 105 may generate multiple sets of (i.e., one or more) coefficients based on the at least two CSI-RS segments and indicate the PMI segments in a CSI report 127 sent to the base station unit 121, where each PMI segment comprises a set of coefficients, each coefficient associated with at least one of a quantized amplitude value and a quantized phase value according to one of at least two quantization schemes. In various embodiments, generating the set of coefficients includes quantizing a first set of coefficients corresponding to the first of the PMI segments according to a first of the at least two quantization schemes and quantizing a second set of coefficients corresponding to a second of the PMI segments according to a second of the at least two quantization schemes.

In various embodiments, the remote units 105 may communicate directly with each other (e.g., device-to-device communication) using sidelink (“SL”) communication 113. Here, SL transmissions may occur on SL resources. A remote unit 105 may be provided with different SL communication resources according to different allocation modes. For example, in 3GPP systems, allocation Mode-1 corresponds to a NR-based network-scheduled SL communication mode, wherein the in-coverage RAN 120 indicates resources for use in SL operation, including resources of one or more resource pools. Allocation Mode-2 corresponds to a NR-based UE-scheduled SL communication mode (i.e., UE-autonomous selection), where the remote unit 105 selects a resource pools and resources therein from a set of candidate pools. Allocation Mode-3 corresponds to an LTE-based network-scheduled SL communication mode. Allocation Mode-4 corresponds to an LTE-based UE-scheduled SL communication mode (i.e., UE-autonomous selection).

As used herein, a “resource pool” refers to a set of resources assigned for SL operation. A resource pool consists of a set of RBs (i.e., Physical Resource Blocks (“PRBs”)) over one or more time units (e.g., subframe, slots, Orthogonal Frequency Division Multiplexing (“OFDM”) symbols). In some embodiments, the set of RBs comprises contiguous PRBs in the frequency domain. A Physical Resource Block (“PRB”), as used herein, consists of twelve consecutive subcarriers in the frequency domain.

In some embodiments, the remote units 105 communicate with an application server 151 (or other communication peer) via a network connection with the mobile core network 140. For example, an application 107 in a remote unit 105 (e.g., a web browser, media client, telephone and/or Voice-over-Internet-Protocol (“VOIP”) application) may trigger the remote unit 105 to establish a protocol data unit (“PDU”) session (or Packet Data Network (“PDN”) connection, or other data connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”) (not shown in FIG. 1) in the mobile core network 140. In certain embodiments, there is a one-to-one mapping between an EPS Bearer and a QoS profile, such that all packets belonging to a specific EPS Bearer have the same QoS Class Identifier (“QCI”).

The base station units 121 may be distributed over a geographic region. In certain embodiments, a base station unit 121 may also be referred to as an access terminal, an access point, a base, a base station, a Node-B (“NB”), an Evolved Node-B (abbreviated as eNodeB or “eNB,” also known as Evolved Universal Terrestrial Radio Access Network (“E-UTRAN”) Node-B), a 5G/NR Node-B (“gNB”), a Home Node-B, a relay node, a RAN node, or by any other terminology used in the art. The base station units 121 are generally part of a RAN, such as the RAN 120, that may include one or more controllers communicably coupled to one or more corresponding base station units 121. These and other elements of radio access network are not illustrated but are well known generally by those having ordinary skill in the art. The base station units 121 connect to the mobile core network 140 via the RAN 120.

The base station units 121 may serve a number of remote units 105 within a serving area, for example, a cell or a cell sector, via a wireless communication link 123. The base station units 121 may communicate directly with one or more of the remote units 105 via communication signals. Generally, the base station units 121 transmit DL communication signals to serve the remote units 105 in the time domain, frequency domain, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base station units 121.

Note that during NR operation on unlicensed spectrum (referred to as “NR-U”), the base station unit 121 and the remote unit 105 communicate over unlicensed (i.e., shared) radio spectrum. Similarly, during LTE operation on unlicensed spectrum (referred to as “LTE-U”), the base station unit 121 and the remote unit 105 also communicate over unlicensed (i.e., shared) radio spectrum.

In various embodiments, the remote unit 105 receives a CSI reporting configuration 125 from the base station unit 121. As described in greater detail below, the CSI reporting configuration 125 may include a CSI reporting setting that is associated with a CMR corresponding to at least two CSI-RS segments, wherein the at least two CSI-RS segments correspond to at least two PMI segments. In various embodiments, there is a one-to-one mapping of CSI-RS segment to PMI segment.

Moreover, after receiving a set of CSI reference signals (“CSI-RS”), the remote unit 105 may generating multiple sets of (i.e., one or more) coefficients based on the at least two CSI-RS segments and indicate the PMI segments in a CSI report 127 sent to the base station unit 121, where each PMI segment comprises a set of coefficients, each coefficient associated with at least one of a quantized amplitude value and a quantized phase value according to one of at least two quantization schemes. In various embodiments, generating the set of coefficients includes quantizing a first set of coefficients corresponding to the first of the PMI segments according to a first of the at least two quantization schemes and quantizing a second set of coefficients corresponding to a second of the PMI segments according to a second of the at least two quantization schemes.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QOS handling, and external PDU session for interconnecting Data Network (“DN”), in the 5G architecture. The AMF 143 is responsible for termination of Non-Access Stratum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 illustrates exemplary components of a 5G RAN and a 5G core network, the described embodiments for precoder restrictions for CSI feedback apply to other types of communication networks and RATs, including IEEE 802.11 variants, Global System for Mobile Communications (“GSM”) (i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station unit, but it is replaceable by any other radio access node, e.g., gNB, ng-eNB, eNB, Base Station (“BS”), base unit, next-generation eNB (“ng-eNB”), Access Point (“AP”), etc. Additionally, the term “UE” is used for the mobile station/remote unit, but it is replaceable by any other remote device, e.g., remote unit, WTRU, MS, ME, etc. Further, the operations are described mainly in the context of 5G NR; however, the proposed solutions/methods are also equally applicable to other mobile communication systems supporting coefficient quantization for CSI feedback under CJT.

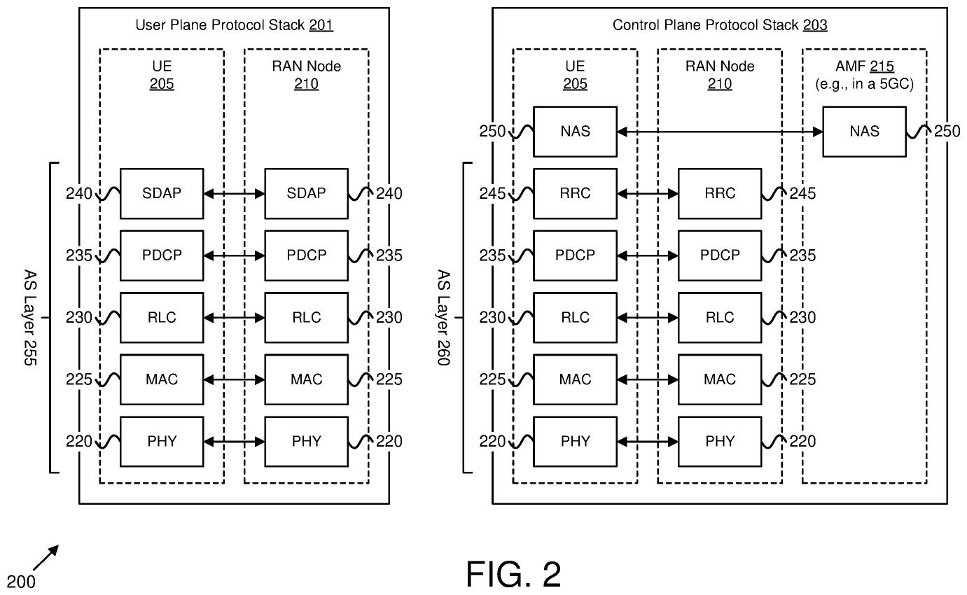

FIG. 2 illustrates an example of a NR protocol stack 200, in accordance with aspects of the present disclosure. While FIG. 2 shows the UE 205, the RAN node 210 and a 5G core network (“5GC”) 215, these are representative of a set of remote units 105 interacting with a base station unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-1 (“L1”) includes the PHY layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF in the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as Transport Blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of Physical Resource Blocks (“PRBs”), etc.

Note that an LTE protocol stack comprises similar structure to the NR protocol stack 200, with the differences that the LTE protocol stack lacks the SDAP sublayer 240 in the AS layer 255 and that the NAS layer 250 is between the UE 205 and an MME in the EPC. Also note that the present disclosure distinguishes between a protocol layer (such as the aforementioned PHY layer 220, MAC sublayer 225, RLC sublayer 230, PDCP sublayer 235, SDAP sublayer 240, RRC layer 245 and NAS layer 250) and a transmission layer in Multiple-Input, Multiple-Output (“MIMO”) communication (also referred to as a “MIMO layer” or a “data stream”).

For the 3GPP NR Rel-16 Type-II codebook with high resolution, the number of Precoding Matrix Indicator (“PMI”) bits fed back from the UE 205 to the RAN node 210 (e.g., gNB) via Uplink Control Information (“UCI”) can be very large (>1000 bits at large bandwidth), even for a single-point transmission. The purpose of multi-panel transmission is to improve the spectral efficiency, as well as the reliability and robustness of the connection in different scenarios, and it covers both ideal and nonideal backhaul. For increasing the reliability using multi-panel transmission, URLLC under multi-panel transmission was agreed, where the UE 205 can be served by multiple TRPs forming a coordination cluster, possibly connected to a central processing unit.

In some embodiments, the presence of K panels may trigger up to 2K−1 possible transmission hypotheses. For instance, at K=4, the following 15 transmission hypotheses may be possible: 4 single-TRP transmission hypotheses for TRPs 1, 2, 3, 4; 6 double-TRP transmission hypotheses for TRP pairs {1,2}, {1,3}, {1,4}, {2,3}, {2,4}, {3,4}; 4 triple-TRP transmission hypotheses for TRP triplets {1,2,3}, {1,2,4}, {1,3,4}, {2,3,4}; and 1 quadruple TRP hypothesis for TRP quadruplet {1,2,3,4}.

Disclosed herein are solutions for efficient reporting inter-TRP co-phasing coefficients for CJT. More specifically, for the purpose of supporting CJT in NR, the following solutions are discussed:

According to a first solution, TRP(s) with stronger channel gain to the UE are associated with precoding matrix(es) that are quantized in both amplitude and phase with higher resolution quantization, whereas two quantization schemes of the precoder coefficients are applied, wherein a first subset of the TRPs with weaker channel gain to the UE are associated with precoding matrix(es) that are quantized in both amplitude and phase with lower resolution quantization.

According to a second solution, TRP(s) with stronger channel gain to the UE are associated with precoding matrix(es) that comprise larger value(s) of a maximum number of non-zero coefficients compared with value(s) of a maximum number of non-zero coefficients corresponding to precoding matrix(es) that are associated with TRP(s) with weaker channel gain to the UE.

In some embodiments, a multi-panel codebook may be provided and used to report CSI for coherent joint transmission (“CJT”). For example, the UE 205 may be configured to reuse the 3GPP Release 15 specification (“Rel-15”) Type-I multi-panel codebook for multi-TRP with co-phasing introduced between two panels. However, Rel-15 Type-I multi-panel codebook co-phasing is designed for the case of two panels, with all panels activate simultaneously, therefore this codebook may be unsuitable to support CJT in NR because under CJT framework more than two panels/TRP may be selected, with a subset of the panels/TRPs may be selected/omitted.

In some embodiments, the UE 205 may report the total number of non-zero coefficients across all precoding matrices (“PMs”) reported in a CSI report. However, while this parameter would successfully characterize the CSI report size, it would not enable identifying the feedback bits corresponding to a particular PMI. Alternatively, if the number of non-zero coefficients are reported separately for each precoding matrix (“PM”), the overhead of the first part of the two CSI report parts (hereafter “CSI report Part 1”) increases significantly, which is undesirable since CSI report Part 1 is encoded with a lower rate compared with the second part of the two CSI report parts (hereafter “CSI report Part 2”).

Regarding the 3GPP NR Rel-15 Type-II Codebook, it is assumed that the gNB is equipped with a two-dimensional (“2D”) antenna array with N1, N2 antenna ports per polarization placed horizontally and vertically and communication occurs over N3 PMI sub-bands. A PMI subband consists of a set of resource blocks, each resource block consisting of a set of subcarriers. In such case, 2N1N2 CSI-RS ports are utilized to enable DL channel estimation with high resolution for NR Rel-15 Type-II codebook. Further details on NR codebook types can be found in 3GPP Technical Specification (“TS”) 38.214.

In order to reduce the UL feedback overhead, a Discrete Fourier Transform (“DFT”)-based CSI compression of the spatial domain (“SD”) is applied to L dimensions per polarization, where L<N₁N₂. In the following, the indices of the 2L dimensions are referred as the SD basis indices. The magnitude and phase values of the linear combination coefficients for each subband are fed back to the gNB as part of the CSI report. The 2N₁N₂×N₃ codebook per transmission layer takes on the form:

$$W = {W}_{1} {W}_{2}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \\ B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] \\ {l}_{i} = {O}_{1} {n}_{1}^{( i )} + {q}_{1} , 0 \leq {n}_{1}^{( i )} < {N}_{1} , 0 \leq {q}_{1} < {O}_{1} \\ {m}_{i} = {O}_{2} {n}_{2}^{( i )} + {q}_{2} , 0 \leq {n}_{2}^{( i )} < {N}_{2} , 0 \leq {q}_{2} < {O}_{2}\end{matrix}$$

where the superscript ^{T} denotes a matrix transposition operation. Note that O₁, O₂ oversampling factors are assumed for the 2D DFT matrix from which matrix B is drawn.

Note that the matrix W₁ is common across all transmission layers. The matrix W₂ is a 2L×N₃ matrix, where the i^{th} column corresponds to the linear combination coefficients of the 2L beams in the i^{th} subband. Only the indices of the L selected columns of B are reported, along with the oversampling index taking on O₁O₂ values. Note that W₂ are independent for different transmission layers.

Regarding 3GPP NR Rel-15, for Type-II Port Selection (“PS”) codebook, only K (where K≤2N₁N₂) beamformed CSI-RS ports are utilized in DL transmission, in order to reduce complexity. The K×N₃ codebook matrix per transmission layer takes on the form:

$$W = {W}_{1}^{PS} {W}_{2}$$

Here, the matrices W₂ follow the same structure as the conventional NR Rel-15 Type-II Codebook and are transmission layer specific.

$${W}_{1}^{PS}$$

is a K×2L block-diagonal matrix with two identical diagonal blocks, i.e.,

$${W}_{1}^{PS} = [ \begin{matrix}E & 0 \\ 0 & E\end{matrix} ] ,$$

and E is a

$$\frac{K}{2} \times L$$

matrix whose columns are standard unit vectors, as follows:

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the UL CSI feedback overhead. The matrix W₁ is common across all transmission layers.

For K=16, L=4 and d_{PS}=1, the 8 possible realizations of E corresponding to m_{PS}={0, 1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , \\ [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ]$$

When d_{PS}=2, the 4 possible realizations of E corresponding to m_{PS}={0,1,2,3} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ]$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

Regarding 3GPP NR Rel-15, the Type-I codebook is the baseline codebook for NR, with a variety of configurations. The most common utility of Rel-15 Type-I codebook is a special case of NR Rel-15 Type-II codebook with L=1 for Rank Indicator (“RI”)=1, 2, wherein a phase coupling value is reported for each subband, i.e., W_{2,1} is 2×N₃, with the first row equal to [1, 1, . . . , 1] and the second row equal to [e^{j2πØ}^{₀}, . . . , e^{j2πØN}^{₃₋₁}]. Under specific configurations, φ₀=φ₁ . . . =φ, i.e., wideband reporting. For RI>2, different beams are used for each pair of transmission layers. The NR Rel-15 Type-I codebook may be depicted as a low-resolution version of NR Rel-15 Type-II codebook with spatial beam selection per transmission-layer-pair and phase combining only.

Regarding the 3GPP NR Rel-16 Type-II Codebook, it is assumed that the gNB is equipped with a 2D antenna array with N₁, N₂ antenna ports per polarization placed horizontally and vertically and communication occurs over N₃ PMI subbands. A PMI subband consists of a set of resource blocks, each resource block consisting of a set of subcarriers. In such case, 2N₁N₂N₃ CSI-RS ports are utilized to enable DL channel estimation with high resolution for NR Rel-16 Type-II codebook. In order to reduce the UL feedback overhead, a DFT-based CSI compression of the SD is applied to L dimensions per polarization, where L<N₁N₂. Similarly, additional compression in the Frequency Domain (“FD”) is applied, where each beam of the FD precoding vectors is transformed using an inverse DFT matrix to the delay domain, and the magnitude and phase values of a subset of the delay-domain coefficients are selected and fed back to the gNB as part of the CSI report.

The 2N₁N₂×N₃ codebook per transmission layer takes on the form:

$$W = {W}_{1} {\tilde{W}}_{2 , l} {W}_{f}^{H}$$

where the matrix W₁ is a 2N₁N₂×2L block-diagonal matrix (L<N₁N₂) with two identical diagonal blocks, i.e.,

$${W}_{1} = [ \begin{matrix}B & 0 \\ 0 & B\end{matrix} ] ,$$

and the matrix B is an N₁N₂×L matrix with columns drawn from a 2D oversampled DFT matrix, as follows:

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2}$$

where the superscript ^{T} denotes a matrix transposition operation, and the superscript ^{H} denotes a matrix Hermitian, i.e., conjugate transposition operator. Note that O₁, O₂ oversampling factors are assumed for the 2D DFT matrix from which matrix Bis drawn. Note that W₁ is common across all transmission layers. In various embodiments, the above parameters comply with 3GPP TS 38.214 definitions and procedures.

The matrices W_{f,l} are an N₃×M matrices (where M<N₃) with columns selected from a critically-sampled size-N₃ DFT matrix, as follows:

$${W}_{f , l} = [ \begin{matrix}{f}_{{k}_{0}} & {f}_{{k}_{1}} & … & {f}_{{k}_{{M}^{′} - 1}}\end{matrix} ] , 0 \leq {k}_{i} \leq {N}_{3} - 1$$

$${f}_{k} = {[ \begin{matrix}1 & {e}^{- j \frac{2 π k}{{N}_{3}}} & … & {e}^{- j \frac{2 π k ( {N}_{3} - 1 )}{{N}_{3}}}\end{matrix} ]}^{T}$$

Only the indices of the L selected columns of B are reported, along with the oversampling index taking on O₁O₂ values. Similarly, for W_{f,l}, only the indices of the M selected columns out of the predefined size-N₃ DFT matrix are reported. In the sequel the indices of the M dimensions are referred as the selected FD basis indices. Hence, L, M represent the equivalent spatial and frequency dimensions after compression, respectively. Finally, the 2L×M matrix \tilde{W}₂ represents the linear combination coefficients (“LCCs”) of the spatial and frequency DFT-basis vectors. Both \tilde{W}_{2,1}, W_{f,l} are selected independently for different transmission layers.

Amplitude (i.e., magnitude) and phase values of an approximately β fraction of the 2LM available coefficients are reported to the gNB (β<1) as part of the CSI report. Note that coefficients with zero magnitude are indicated via a per-transmission layer bitmap. Since all coefficients reported within a transmission layer are normalized with respect to the coefficient with the largest magnitude (strongest coefficient), the relative value of that coefficient is set to unity (i.e., one), and no magnitude or phase information is explicitly reported for this coefficient. Only an indication of the index of the strongest coefficient per transmission layer is reported. Hence, amplitude and phase values of a maximum of [2βLM]−1 coefficients (along with the indices of selected L, M DFT vectors) are reported per transmission layer, leading to significant reduction in CSI report size, compared with reporting 2N₁N₂×N₃−1 coefficients' information of a theoretical design.

Regarding 3GPP NR Rel-16, for Type-II PS codebook, only K beamformed CSI-RS ports are utilized in DL transmission (where K≤2N₁N₂), in order to reduce complexity. The K×N₃ codebook matrix per transmission layer takes on the form:

$$W = {W}_{1}^{PS} {\tilde{W}}_{2} {W}_{f}^{H}$$

where the superscript ^{H} denotes a matrix Hermitian, i.e., conjugate transposition operator.

Here, \tilde{W}₂ and W_{f} follow the same structure as the conventional NR Rel-16 Type-II Codebook, described above, where both are transmission layer specific. The matrix

$${W}_{1}^{PS}$$

is a K×2L block-diagonal matrix with the same structure as that in the NR Rel-15 Type-II PS Codebook, described above.

Regarding codebook reporting, the CSI codebook report may be partitioned into two parts based on the priority of information reported. Each part is encoded separately. Note that Part 1 of the codebook report (i.e., CSI report Part 1) may possibly have a higher code rate. Below is listed list the parameters for NR Rel-16 Type-II codebook only. More details can be found in TS 38.214, Sections 5.2.3 and 5.2.4.

Regarding the contents of the CSI report, the CSI report Part 1 comprises a RI, plus a Channel Quality Indicator (“CQI”), plus the total number of coefficients (i.e., represented using a single value). The CSI report Part 2 comprises a SD basis indicator, plus a FD basis indicator per transmission layer, plus a bitmap per transmission layer, plus coefficient amplitude information per transmission layer, plus coefficient phase information per transmission layer, plus a strongest coefficient indicator per transmission layer.

Furthermore, the CSI report Part 2 can be decomposed into sub-parts each with different priority (higher priority information listed first). Such partitioning is required to allow dynamic reporting size for codebook based on available resources in the uplink phase. More details can be found in 3GPP TS 38.214, Section 5.2.3.

Also Type-II codebook is based on aperiodic CSI reporting, and only reported in PUSCH via Downlink Control Information (“DCI”) triggering (one exception). Type-I codebook can be based on periodic CSI reporting (e.g., PUCCH) or semi-persistent CSI reporting (e.g., PUSCH or PUCCH) or aperiodic reporting (e.g., PUSCH).

Regarding priority reporting for the CSI report Part 2, note that multiple (i.e., up to N_{Rep}) CSI reports may be transmitted, whose priority are shown in Table 1, below:

TABLE 1
CSI Reports priority ordering

```
    Priority 0:
    For CSI reports 1 to N_{Rep},
Group 0 CSI for CSI reports configured as 'typeII-r16' or
'typeII-PortSelection-r16'; Part 2 wideband CSI for CSI reports configured otherwise
    Priority 1:
    Group 1 CSI for CSI report 1, if configured as 'typeII-r16' or 'typeII-PortSelection-r16';
Part 2 subband CSI of even subbands for CSI report 1, if configured otherwise
    Priority 2:
    Group 2 CSI for CSI report 1, if configured as 'typeII-r16' or 'typeII-PortSelection-r16';
Part 2 subband CSI of odd subbands for CSI report 1, if configured otherwise
    Priority 3:
    Group 1 CSI for CSI report 2, if configured as 'typeII-r16' or 'typeII-PortSelection-r16';
Part 2 subband CSI of even subbands for CSI report 2, if configured otherwise
    Priority 4:
    Group 2 CSI for CSI report 2, if configured as 'typeII-r16' or 'typeII-PortSelection-r16'.
Part 2 subband CSI of odd subbands for CSI report 2, if configured otherwise
.
.
.
.
    Priority 2N_{Rep} − 1:
    Group 1 CSI for CSI report N_{Rep}, if configured as 'typeII-r16' or 'typeII-PortSelection-
r16'; Part 2 subband CSI of even subbands for CSI report N_{Rep}, if configured otherwise
    Priority 2N_{Rep}:
    Group 2 CSI for CSI report N_{Rep}, if configured as 'typeII-r16' or 'typeII-PortSelection-
r16'; Part 2 subband CSI of odd subbands for CSI report N_{Rep}, if configured otherwise
```

Note that the priority of the N_{Rep} CSI reports are based on the following: A CSI report corresponding to one CSI reporting configuration for one cell may have higher priority compared with another CSI report corresponding to one other CSI reporting configuration for the same cell; CSI reports intended to one cell may have higher priority compared with other CSI reports intended to another cell; CSI reports may have higher priority based on the CSI report content, e.g., CSI reports carrying L1 Reference Signal Received Power (“L1-RSRP”) information have higher priority; and CSI reports may have higher priority based on their type, e.g., whether the CSI report is aperiodic, semi-persistent or periodic, and whether the report is sent via PUSCH or PUCCH, may impact the priority of the CSI report.

In light of that, CSI reports may be prioritized as follows, where CSI reports with lower IDs have higher priority:

$$P r {i}_{iCSI} ( y , k , c , s ) = 2 \cdot {N}_{c e l l s} \cdot {M}_{s} \cdot y + {N}_{c e l l s} \cdot {M}_{s} \cdot k + {M}_{s} \cdot c + s$$

where s represents the CSI reporting configuration index; Ms represents the maximum number of CSI reporting configurations; c represents Cell index, Ncells represents the number of serving cells; k has a value of 0 for CSI reports carrying L1-RSRP or L1 Signal-to-Interference-plus-Noise Ratio (“L1-SINR”), and a value of 1 otherwise; and y has a value of 0 for aperiodic reports, a value of 1 for semi-persistent reports on PUSCH, a value of 2 for semi-persistent reports on PUCCH, and a value of 3 for periodic reports.

Regarding UCI Bit Sequence Generation, the bitwidth for RI, Layer Indicator (“L1”), Wideband (“WB”) CQI for the first TB, WB CQI for the second TB, Subband differential (“ΔSB”) CQI for the first TB, ΔSB CQI for the second TB and CSI-RS Resource Indicator (“CRI”) of codebookType=typeI-SinglePanel is provided in Table 2, below:

TABLE 2
RI, LI, CQI, and CRI of Type-I single-panel codebook

| | Bitwidth | | | | |
|---|---|---|---|---|---|
| | | | | >4 antenna ports | |
| | 1 | 2 | 4 | Rank1 | Rank5 |
| Field | antenna port | antenna ports | antenna ports | ~4 | ~8 |
| RI | 0 | min(1, ┌log₂ n_{RI}┐) | min(2, ┌log₂ N_{RI}┐) | ┌log₂ N_{RI}┐ | ┌log₂ n_{RI}┐ |
| LI | 0 | ┌log₂ υ] | min (2, ┌log₂ v]) | min(2, ┌log₂ v┐) | min(2, ┌log₂ v┐) |
| W | 4 | 4 | 4 | 4 | 4 |
| B CQI for | | | | | |
| the 1st TB | | | | | |
| W | 0 | 0 | 0 | 0 | 4 |
| B CQI for | | | | | |
| the 2nd TB | | | | | |
| ΔS | 2 | 2 | 2 | 2 | 2 |
| B CQI for | | | | | |
| the 1st TB | | | | | |
| ΔS | 0 | 0 | 0 | 0 | 2 |
| B CQI for | | | | | |
| the 2nd TB | | | | | |
| CRI | $⌈ {log}_{2} {K}_{S}^{C S 1 - R S} ⌉$ | $⌈ {log}_{2} {K}_{S}^{C S 1 - R S} ⌉$ | $⌈ {log}_{2} {K}_{S}^{C S 1 - R S} ⌉$ | $⌈ {log}_{2} {K}_{S}^{C S 1 - R S} ⌉$ | $⌈ {log}_{2} {K}_{S}^{C S 1 - R S} ⌉$ |

In Table 2, n_{RI}, ν, and

$${K}_{s}^{CSI - RS}$$

are the number of allowed rank indicator values, the value of the rank and the number of CSI-RS resources in the corresponding resource set, respectively, according to Clause 5.2.2.2.1 of 3GPP TS 38.214. The values of the rank indicator field are mapped to allowed rank indicator values with increasing order, where ‘0’ is mapped to the smallest allowed rank indicator value.

Additional information regarding the CSI report number is described below in Tables 3-8.

TABLE 1
Mapping order of CSI fields of one CSI report
with wideband PMI and wideband CQI

| CSI | |
|---|---|
| report | |
| number | CSI fields |
| CSI | CRI as in Tables 6.3.1.1.2-3/4 in 3GPP TS 38.214, if reported |
| report #n | Rank Indicator as in Tables 6.3.1.1.2-3/4 in 3GPP TS 38.214, if |
| | reported |
| | Layer Indicator as in Tables 6.3.1.1.2-3/4 in 3GPP TS 38.214, if |
| | reported |
| | Zero padding bits Oₚ, if needed |
| | PMI wideband information fields X₁, from left to right as in Tables |
| | 6.3.1.1.2-1/2 in 3GPP TS 38.214, if reported |
| | PMI wideband information fields X2, from left to right as in Tables |
| | 6.3.1.1.2-1/2 in 3GPP TS 38.214, or codebook index for 2 antenna ports |
| | according to Clause 5.2.2.2.1 in 3GPP TS 38.214, if reported |
| | Wideband CQI for the first TB as in Tables 6.3.1.1.2-3/4 in 3GPP |
| | TS 38.214, if reported |
| | Wideband CQI for the second TB as in Tables 6.3.1.1.2-3/4 in 3GPP |
| | TS 38.214, if reported |

TABLE 2
Mapping order of CSI report Part 1 fields of a
CSI report, with sub-band PMI or sub-band CQI

| CSI | |
|---|---|
| report | |
| number | CSI fields |
| CSI | CRI as in Tables 6.3.1.1.2-3/4 in 3GPP TS 38.214, if reported |
| report #n | Rank Indicator as in Tables 6.3.1.1.2-3/4/5 in 3GPP TS 38.214, if |
| | reported |
| CSI part | Wideband CQI for the first TB as in Tables 6.3.1.1.2-3/4/5 in |
| 1 | 3GPP TS 38.214, if reported |
| | Subband differential CQI for the first TB with increasing order of |
| | subband number as in Tables 6.3.1.1.2-3/4/5 in 3GPP TS 38.214, if |
| | reported |
| | Indicator of the number of non-zero wideband amplitude |
| | coefficients M₀ for Layer 0 as in Table 6.3.1.1.2-5 in 3GPP TS 38.214, if |
| | reported |
| | Indicator of the number of non-zero wideband amplitude |
| | coefficients M₁ for Layer 1 as in Table 6.3.1.1.2-5 in 3GPP TS 38.214 (if |
| | the rank according to the reported RI is equal to one, this field is set to all |
| | zeros), if 2-layer PMI reporting is allowed according to the rank restriction |
| | in Clauses 5.2.2.2.3 and 5.2.2.2.4 in 3GPP TS 38.214 and if reported |

Note:
Subbands for given CSI report n indicated by the higher-layer parameter csi-ReportingBand are numbered continuously in the increasing order with the lowest subband of csi-ReportingBand as subband 0.

TABLE 3
Mapping order of wideband CSI report Part 2 fields of
a CSI report with sub-band PMI or sub-band CQI

| CSI | |
|---|---|
| report | |
| number | CSI fields |
| CSI | Wideband CQI for the second TB as in Tables 6.3.1.1.2-3/4/5 in |
| report | 3GPP TS 38.214, if present and reported |
| #n | Layer Indicator as in Tables 6.3.1.1.2-3/4/5 in 3GPP TS 38.214, |
| CSI | if reported |
| part 2 | PMI wideband information fields X₁, from left to right as in |
| wideband | Tables 6.3.1.1.2-1/2 in 3GPP TS 38.214, if reported |
| | PMI wideband information fields X₂, from left to right as in Tables |
| | 6.3.1.1.2-1/2 in 3GPP TS 38.214, or codebook index for 2 antenna |
| | ports according to Clause 5.2.2.2.1 in 3GPP TS 38.214, if |
| | pmi-FormatIndicator=widebandPMI and if reported |

TABLE 4
Mapping order of sub-band CSI report Part 2 fields of
a CSI report with sub-band PMI or sub-band CQI

| | |
|---|---|
| CSI | Subband differential CQI for the second TB of all even subbands with |
| report | increasing order of subband number, as in Tables 6.3.1.1.2-3/4/5 in 3GPP TS |
| #n | 38.214, if cqi-FormatIndicator=subbandCQI and if reported |
| Part 2 | PMI subband information fields X₂ of all even subbands with increasing |
| subband | order of subband number, from left to right as in Tables 6.3.1.1.2-1/2 in 3GPP |
| | TS 38.214, or codebook index for 2 antenna ports according to Clause 5.2.2.2.1 |
| | in 3GPP TS 38.214 of all even subbands with increasing order of subband |
| | number, if pmi-FormatIndicator=subbandPMI and if reported |
| | Subband differential CQI for the second TB of all odd subbands with |
| | increasing order of subband number, as in Tables 6.3.1.1.2-3/4/5 in 3GPP TS |
| | 38.214, if cqi-FormatIndicator=subbandCQI and if reported |
| | PMI subband information fields X₂ of all odd subbands with increasing |
| | order of subband number, from left to right as in Tables 6.3.1.1.2-1/2 in 3GPP |
| | TS 38.214, or codebook index for 2 antenna ports according to Clause 5.2.2.2.1 |
| | in 3GPP TS 38.214 of all odd subbands with increasing order of subband |
| | number, if pmi-FormatIndicator=subbandPMI and if reported |

Note that sub-bands for given CSI report n indicated by the higher-layer parameter csi-ReportingBand are numbered continuously in the increasing order with the lowest subband of csi-ReportingBand as subband 0.

TABLE 5
Mapping order of CSI Part 2 fields of a CSI report with ‘typeII-r16’ or ‘typeII-
PortSelection-r16’ codebook

| CSI | |
|---|---|
| report number | CSI fields |
| CSI | PMI fields X₁, from left to right as in Tables 6.3.2.1.2-1A/2A in |
| report #n | 3GPP TS 38.214, if reported |
| CSI | |
| part 2, group 0 | |
| CSI | The following PMI fields X₂, from left to right, as in Tables |
| report #n CSI | $632.1 \text{.2} - 1 A / 2 A : \{ {i}_{2 , 3 , l} : l = 1 , … , υ \} , {i}_{1 , 5} , \{ {i}_{1 , 6 , l} : l = 1 , … , υ \} and ( ⌈ \frac{{K}^{N Z}}{2} ⌉ -$ |
| part 2, group 1 | υ) × 3 highest priority bits of |
| | {i_{2,4,l}: l = 1, ... , υ}, (┌K^{NZ}/2┐ − υ) × 4 highest priority bits of |
| | {i_{2,5,l}: l = 1, ... , υ} and v * 2LM_{υ} − └K^{NZ}/2] highest priority bits |
| | of {i_{1,7,l}: l = 1, ... , υ}, in decreasing order of priority based on function |
| | Pri(l, i, f) defined in clause 5.2.3 of 3GPP TS 38.214, if reported |
| CSI | The following PMI fields X₂, from left to right, as in Tables |
| report #n | 6.3.2.1.2-1A/2A: └K^{NZ}/2] × 3 lowest priority bits of {i_{2,4,l}: l = |
| CSI | 1, ... , υ], [K^{NZ}/2] × 4 lowest priority bits of {i_{2,5,l}: l = 1, ... , υ} and [K^{NZ}/2] |
| part 2, group 2 | lowest priority bits of {i_{1,7,l}: l = 1, ... , υ}, in decreasing order of priority |
| | based on function Pri(l, i, f) defined in clause 5.2.3 of 3GPP TS 38.214, if |
| | reported |

The CSI report content in UCI, whether on PUCCH or PUSCH, is provided in detail in 3GPP TS 38.212. The Rank Indicator (“RI”), if reported, has bitwidth of min (└log₂ Nₚₒᵣₜₛ┘, └log₂ n_{RI}┘), where Nₚₒᵣₜₛ, n_{RI} represent the number of antenna ports and the number of allowed rank indicator values, respectively. On the other hand, the CRI and the Synchronization Signal Block Resource Indicator (“SSBRI”) each have bitwidths of

$$⌈ {log}_{2} {K}_{s}^{CSI - RS} ⌉ , ⌈ {log}_{2} {K}_{s}^{S S B} ⌉ ,$$

respectively, where

$${K}_{s}^{CSI - RS}$$

is the number of CSI-RS resources in the corresponding resource set, and

$${K}_{s}^{S S B}$$

is the configured number of Synchronization Signal/Physical Broadcast Channel (“SS/PBCH”) blocks in the corresponding resource set for reporting ‘ssb-Index-RSRP’. The mapping order of CSI fields of one CSI report with wideband PMI and wideband CQI on PUCCH is depicted in Table 6, is as follows:

TABLE 6
Mapping order of CSI fields of one CSI report
with wideband PMI and CQI on PUCCH

| CSI | |
|---|---|
| report | |
| number | CSI fields |
| CSI | CRI, if reported |
| report | Rank Indicator, if reported |
| #n | Layer Indicator, if reported |
| | Zero padding bits, if needed |
| | PMI wideband information fields, if reported |
| | PMI wideband information, if reported |
| | Wideband CQI for the first Transport Block, if reported |
| | Wideband CQI for the second Transport Block, if reported |

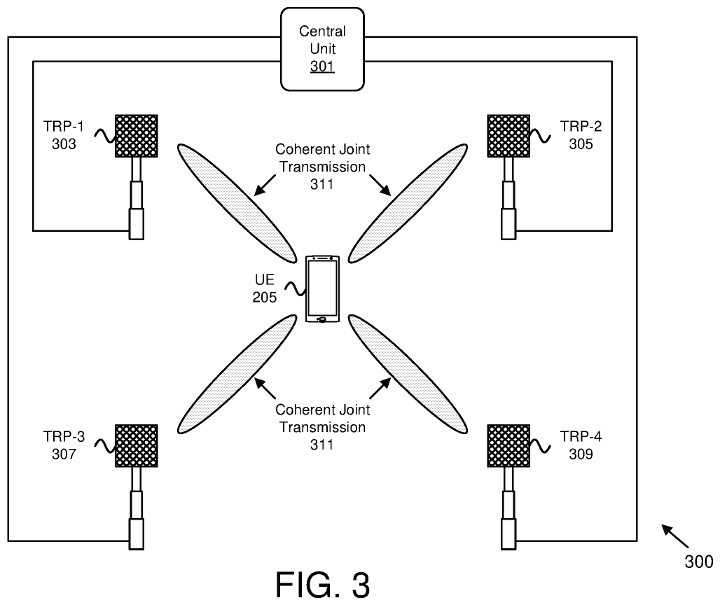

FIG. 3 illustrates an exemplary scenario 300 of CJT to a UE 205 served by multiple TRPs in a coordination cluster connected to a central unit 301, in accordance with aspects of the present disclosure. In the depicted example, the central unit 301 is controls a first TRP 303 (denoted (“TRP-1”), a second TRP 305 (denoted (“TRP-2”), a third TRP 307 (denoted (“TRP-3”), and a fourth TRP 309 (denoted (“TRP-4”). The multiple TRPs 303-309 serving the UE 205 form a coordination cluster. As noted above, the multiple TRPs 303-309 may be placed in geographically distinct/remote locations. The multiple TRPs 303-309 within a cell may use coherent joint transmissions 311 to communicate simultaneously with the UE 205 to enhance coverage, throughput, and reliability. The different TRPs 303-309 may be allocated different CSI-RS resources, e.g., each TRP 303-309 associated with a distinct CSI-RS partition (also referred to herein as a “CSI-RS unit”), as described in greater detail below. The UE 205 generates (and transmits) a CSI report based on a set of NZP CSI-RS received from one or more of the TRPs 303-309, as described in greater detail below. As used herein, a CSI-RS unit may be referred to as a CSI-RS segment.

As used herein, the following terms are used interchangeably: TRP, panel, set of antennas, set of antenna ports, uniform linear array, cell, node, radio head, communication (e.g., signals/channels) associated with a control resource set (“CORESET”) pool, communication associated with a Transmission Configuration Indicator (“TCI”) state from a transmission configuration comprising at least two TCI states.

Note that for the below described solutions, the codebook type used is arbitrary; flexibility for use different codebook types, e.g., Type-II Rel-16 codebook, Type-II Release 17 (“Rel-17”) codebook, etc. Several solutions are described below. According to a possible embodiment, one or more elements or features from one or more of the described solutions may be combined.

Embodiments of the first solution relate to resource allocation and PMI reporting per TRP. Regarding CSI-RS resource allocation corresponding to the K TRPs, each of the multiple TRPs associated with joint transmission, e.g., coherent joint transmissions 311, to the UE 205 is associated with a distinct (e.g., exclusive) group of CSI-RS units for channel measurement, e.g., K CSI-RS units corresponding to K TRPs, as follows:

In a first implementation of CSI-RS resource allocation for K TRPs, each CSI-RS unit corresponds to a distinct group of CSI-RS ports within a same NZP CSI-RS resource. In other words, K CSI-RS port groups per CSI-RS resource, which value may be configured by RRC signaling. In a first example, an NZP CSI-RS resource comprising N CSI-RS ports is decomposed into K groups of N/K exclusive CSI-RS ports, wherein each CSI-RS port group is associated with a distinct TRP.

In a second example, a CSI-RS resource comprising N CSI-RS ports is decomposed into K groups of n₁, n₂, . . . , nₖ exclusive CSI-RS ports, wherein n₁+n₂+ . . . +nₖ=N. The CSI-RS port grouping is based on one or more of a pre-defined rule, and higher-layer signaling, e.g., based on MAC control element (“CE”) or RRC signaling. In a third example, each CSI-RS port group corresponds to a different/distinct Code Division Multiplexing (“CDM”) group. In other words, there may be a different CDM group per CSI-RS port group.

In a second implementation of CSI-RS resource allocation for K TRPs, the number of CSI-RS port groups is no larger than the number of CDM groups corresponding to the NZP CSI-RS resource. In other words, the number of CSI-RS port groups (i.e., K) is less than or equal to the number of CDM groups.

In a third implementation of CSI-RS resource allocation for K TRPs, each CSI-RS unit corresponds to a distinct NZP CSI-RS resource of an NZP CSI-RS resource set, i.e., a total of K NZP CSI-RS resources within a same NZP CSI-RS resource set are associated with the TCI state(s) corresponding to PDSCH transmission. Under this implementation, an NZP CSI-RS resource ID codepoint may correspond to more than one NZP CSI-RS resource. In other words, there are K CSI-RS resources, with a CSI-RS resource ID codepoint corresponding to K CSI-RS resources.

Regarding PMI allocation corresponding to the K TRPs, Each of the multiple TRPs associated with joint transmission to one UE, e.g., via coherent joint transmission, is associated with a distinct/exclusive group of PMI segments that are reported by the UE to the network, e.g., K PMI segments corresponding to the K TRPs, as considered in the following implementations.

In a first implementation of PMI allocation, K PMI segments associated with the K CSI-RS units correspond to K distinct PMI quantities. In a first example, a CSI report that is associated with K selected/indicated CSI-RS units comprises K PMI quantities in the CSI report. In a second example, a CSI report that is associated with K selected/indicated CSI-RS units comprises K codewords of PMI quantities in the CSI report. In a third example, the K PMI quantities/codewords reported are selected based on one or more of a pre-defined rule, higher-layer signaling, e.g., MAC CE or RRC signaling, or selected by the UE. In other words, in this implementation there are K PMIs corresponding to K CSI-RS units and K TRPs.

In a second implementation of PMI allocation, K PMI segments associated with the K CSI-RS units correspond to K partitions of a PMI quantity. In a first example, PMI parameters of the PMI quantity correspond to a set of beams that are further decomposed into K distinct subsets of beams, wherein each PMI segment of the K PMI segments is associated with a subset of beams of the K distinct subsets of beams. In a second example, PMI parameters of the PMI quantity correspond to a set of CSI-RS ports that are further decomposed into K distinct subsets of CSI-RS ports, wherein each PMI segment of the K PMI segments is associated with a subset of CSI-RS ports of the K distinct subsets of CSI-RS ports. In other words, in this implementation there are K PMI partitions of a common PMI quantity corresponding to K CSI-RS units and K TRPs.

Regarding multiple groups of PMI segments, in various embodiments the K PMI segments may be categorized into at least two groups of PMI segments. In a first implementation of grouping PMI segments into multiple groups, an indicator of a PMI segments corresponding to a first group of PMI segments of the two groups of PMI segments is either reported by the UE in the CSI report, or configured by the network, or set by a rule, or some combination thereof.

In a first example, the indicator of PMI segments is in a form of a bitmap of a length equal to the number of PMI segments reported in the CSI report, wherein a bit value of one in a k^{th} bit of the bitmap indicates that the k^{th} PMI segment is a member of the first group of PMI segments. In other words, the PMI grouping may be indicated via a bitmap in this implementation.

In a second example, the indicator of PMI segments is in a form of an encoded value from a codebook of a set of encoded values, wherein each encoded from the codebook of the set of encoded values corresponds to a distinct combination of PMI segments corresponding to the first group of PMI segments. In other words, the PMI grouping may be indicated via a combinatorial value in this implementation.

In a third example, the indicator of PMI segments is in the form of an indicator of CSI-RS units, wherein each CSI-RS unit is mapped to a PMI segment via a one-to-one transformation. In other words, there may be a mapping of PMI segments to CSI-RS units according to aspects of this implementation.

In a second implementation of grouping PMI segments into multiple groups, the first group of PMI segments of the two groups of PMI segments comprises one PMI segment. In other words, one PMI group may comprise one PMI segment, according to aspects of this implementation.

In a third implementation of grouping PMI segments into multiple groups, the first group of PMI segments of the two groups of PMI segments correspond to the strongest PMI segments compared with PMI segments of a second group of PMI segments of the two groups of PMI segments. In other words, one PMI group may correspond to the strongest of the PMI segments, according to aspects of this implementation.

Embodiments of a second solution relate to quantization schemes corresponding to the multiple groups of PMI segments. In various embodiments of the second solution, each PMI segment corresponds to a set of coefficients, where a subset of coefficients of the set of coefficients has non-zero values. In such embodiments, each coefficient of the subset of coefficients with non-zero values is represented via at least one of an amplitude value and a phase value, where the amplitude value is selected from a codebook of amplitude values, and the phase value is selected from a codebook of phase values.

As used herein, the term “quantization scheme” refers to a combination of at least the codebook of amplitude values (also referred to as a “amplitude codebook”) and the codebook of phase values (also referred to as a “phase codebook”). In some embodiments, the quantization scheme may be a combination that includes additional codebooks, as described in further detail below. In various embodiments, one or more elements or features from the embodiments described below may be combined. In certain embodiments, the amplitude codebooks of the multiple groups of PMI segments are the same size and/or have the same resolution. In certain embodiments, the phase codebooks of the multiple groups of PMI segments are the same size and/or have the same resolution. In other embodiments, the different quantization schemes may have different resolutions, as described below.

In a first embodiment of the second solution, the UE is configured with two quantization schemes, where coefficients of the first group of PMI segments are associated with a first of the two quantization schemes and coefficients of the second group of PMI segments are associated with a second of the two quantization schemes. In other words, a different quantization scheme is applied to each PMI segment in this embodiment.

In a second embodiment of the second solution, the codebooks of amplitude values have different resolutions (i.e., different codebook sizes), such that the amplitude codebook associated with the stronger PMI segments has a higher resolution as compared to the amplitude codebook(s) associated with the weaker PMI segments. Accordingly, the amplitude codebook corresponding to the first quantization scheme (i.e., applied to the stronger PMI segments) contains a greater number of amplitude values compared with the amplitude codebook corresponding to the second quantization scheme (i.e., applied to the weaker PMI segments).

In a first example of the second embodiment, the codebook of amplitude values corresponding to the second quantization scheme is a subset of the codebook of amplitude values corresponding to the first quantization scheme. Accordingly, the amplitude codebook of the weaker PMI segments may be a subset of that of the stronger PMI segments.

In a second example of the second embodiment, the number of amplitude values of the codebook of amplitude values corresponding to the first quantization scheme is a power-of-two multiple of the number of amplitude values of the codebook of amplitude values corresponding to the second quantization scheme, e.g.,

$${N}_{C {B}_{1}}^{amp} = {2}^{α} \cdot {N}_{C {B}_{2}}^{amp} , where {N}_{C {B}_{j}}^{amp}$$

corresponds to the number of amplitude values of the codebook of amplitude values corresponding to the j^{th} quantization scheme, where j=1, 2, and ‘a’ is a non-negative integer value. Under this example, a number of bits representing a selected amplitude value corresponding to the first quantization scheme requires ‘a’ additional bits compared with a number of bits representing the selected amplitude value corresponding to the second quantization scheme. Accordingly, more bits are associated with the amplitude quantization of stronger PMI segments and the bitwidth (i.e., the number of bits needed to represent the quantization value) per number of non-zero coefficients of the stronger PMI segments is larger than the bitwidth per non-zero coefficient of the remainder of (i.e., weaker) PMI segments.

In a third example of the second embodiment, the codebook of amplitude values corresponding to the first quantization scheme is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{4} , \frac{1}{8 \sqrt{2}} \} ,$$

and the codebook of amplitude values corresponding to the second quantization scheme is

$$\{ 1 , \frac{1}{2} , \frac{1}{4} , \frac{1}{4} \} .$$

In a third embodiment of the second solution, the codebooks of phase values have different resolutions (i.e., different codebook sizes), such that the phase codebook associated with the stronger PMI segments has a higher resolution as compared to the phase codebook(s) associated with the weaker PMI segments. Accordingly, the phase codebook corresponding to the first quantization scheme (i.e., applied to the stronger PMI segments) contains a greater number of phase values compared with the phase codebook corresponding to the second quantization scheme (i.e., applied to the weaker PMI segments).

In a first example of the third embodiment, the codebook of phase values corresponding to the second quantization scheme is a subset of the codebook of phase values corresponding to the first quantization scheme. Accordingly, the phase codebook of the weaker PMI segments may be a subset of that of the stronger PMI segments.

In a second example of the third embodiment, the number of phase values of the codebook of phase values corresponding to the first quantization scheme is a power-of-two multiple of the number of phase values of the codebook of phase values corresponding to the second quantization scheme, e.g.,

$${N}_{C {B}_{1}}^{p h a s e} = {2}^{p} \cdot {N}_{C {B}_{2}}^{p h a s e} ,$$

wherein

$${N}_{C {B}_{j}}^{p h a s e}$$

corresponds to the number of phase values of the codebook of phase values corresponding to the j^{th} quantization scheme, where j=1, 2, and ‘p’ is a non-negative integer value. Under this example, a number of bits representing a selected phase value corresponding to the first quantization scheme requires ‘p’ additional bits compared with a number of bits representing a selected phase value corresponding to the second quantization scheme. Accordingly, more bits are associated with the phase quantization of stronger PMI segments and the bitwidth (i.e., the number of bits needed to represent the quantization value) per non-zero coefficient of the stronger PMI segments is larger than the bitwidth per non-zero coefficient of the remainder of (i.e., weaker) PMI segments.

In a third example of the third embodiment, the codebook of phase values corresponding to the first quantization scheme is

$${\{ {e}^{j \frac{2 π c}{16}} \}}_{c = 0}^{15} ,$$

i.e., a codebook of 16 values with a parameter c taking on values c=0, 1, . . . , 15, and the codebook of phase values corresponding to the second quantization scheme is

$${\{ {e}^{j \frac{2 π d}{8}} \}}_{d = 0}^{7} ,$$

i.e., a codebook of 8 values with a parameter d taking on values c=0, 1, . . . , 7.

In a fourth embodiment of the second solution, each coefficient of the subset of coefficients a with a non-zero values is further represented via an additional reference amplitude value. As used here, a reference amplitude value refers to an amplitude value that is common for a subset of the set of coefficients corresponding to a PMI segment. In various embodiments of the fourth embodiment, the reference amplitude value is selected from a codebook of reference amplitude values, where the selected reference amplitude value is common for non-zero valued coefficients of the subset of coefficients with a same polarization of a PMI segment. In the fourth embodiment, the quantization scheme is a combination of the codebook of amplitude values, the codebook of phase values, and a codebook of reference amplitude values (also referred to as “reference amplitude codebook”). As used here, a reference amplitude value refers to an amplitude value that is common for a subset of the set of coefficients corresponding to a PMI segment.

In various implementations of the fourth embodiment, the codebooks of reference amplitude values have different resolutions (i.e., different codebook sizes), such that the reference amplitude codebook associated with the stronger PMI segments has a higher resolution as compared to the reference amplitude codebook(s) associated with the weaker PMI segments. Accordingly, the reference amplitude codebook corresponding to the first quantization scheme (i.e., applied to the stronger PMI segments) contains a greater number of reference amplitude values compared with the reference amplitude codebook corresponding to the second quantization scheme (i.e., applied to the weaker PMI segments).

In a first example of the fourth embodiment, the codebook of reference amplitude values corresponding to the second quantization scheme is a subset of the codebook of reference amplitude values corresponding to the first quantization scheme. Accordingly, the reference amplitude codebook of the weaker PMI segments may be a subset of that of the stronger PMI segments.

In a second example of the fourth embodiment, the number of reference amplitude values of the codebook of reference amplitude values corresponding to the first quantization scheme is a power-of-two multiple of the number of reference amplitude values of the codebook of reference amplitude values corresponding to the second quantization scheme, e.g.,

$${N}_{C {B}_{1}}^{r e f} = {2}^{r} \cdot {N}_{C {B}_{2}}^{r e f} ,$$

where

$${N}_{{CB}_{j}}^{ref}$$

corresponds to the number of reference amplitude values of the codebook of phase values corresponding to the j^{th} quantization scheme, where j=1, 2, and ‘r’ is a non-negative integer value. Under this example, a number of bits representing a selected phase value corresponding to the first quantization scheme requires ‘r’ additional bits compared with a number of bits representing a selected phase value corresponding to the second quantization scheme. Accordingly, more bits are associated with the reference amplitude quantization of stronger PMI segments and the bitwidth (i.e., the number of bits needed to represent the quantization value) per number of non-zero coefficients of the stronger PMI segments is larger than the bitwidth per non-zero coefficient of the remainder of (i.e., weaker) PMI segments.

In a third example of the fourth embodiment, the codebook of reference amplitude values corresponding to the first quantization scheme is

$$\{ 1 , {( \frac{1}{2} )}^{\frac{1}{4}} , \frac{1}{\sqrt{2}} , {( \frac{1}{8} )}^{\frac{1}{4}} , \frac{1}{2} , {( \frac{1}{32} )}^{\frac{1}{4}} , \frac{1}{\sqrt{8}} , {( \frac{1}{128} )}^{\frac{1}{4}} , \\ \frac{1}{4} , {( \frac{1}{512} )}^{\frac{1}{4}} , \frac{1}{2 \sqrt{8}} , {( \frac{1}{2048} )}^{\frac{1}{4}} , \frac{1}{8} , {( \frac{1}{8192} )}^{\frac{1}{4}} , \frac{1}{\sqrt{128}} \} ,$$

and the codebook of reference amplitude values corresponding to the second quantization scheme is

$$\{ 1 , \frac{1}{\sqrt{2}} , \frac{1}{2} , \frac{1}{\sqrt{8}} \} .$$

In a fourth example of the fourth embodiment, at most two reference amplitude values are associated with each PMI segment of the first group of PMI segments (i.e., the PMI segments associated with strongest channel gains), where a first of the at most two reference amplitude values corresponds to non-zero coefficients associated with a first polarization of the two polarizations, and a second of the at most two reference amplitude values corresponds to non-zero coefficients associated with a second polarization of the two polarizations. In one embodiment, the two polarizations are different linear polarizations. In other embodiments, the two polarizations are different circular polarizations.

In a fifth example of the fourth embodiment, at most one reference amplitude value is associated with each PMI segment of the second group of PMI segments (i.e., the PMI segments associated with weakest channel gains), where the at most one reference amplitude value corresponds to all non-zero coefficients associated with the PMI segment.

In a fifth embodiment of the second solution, a first polarization of two polarizations is associated with at least one of a first group of spatial beams of two groups of spatial beams of each PMI. A second polarization of the two polarizations is associated with at least one of a second group of spatial beams of the two groups of spatial beams of each PMI. Alternatively, the first polarization is associated with a first group of CSI-RS ports of the two groups of CSI-RS ports of each PMI and the second polarization is associated with a first group of CSI-RS ports of two groups of CSI-RS ports of each PMI. In one embodiment, the two polarizations are different linear polarizations. In other embodiments, the two polarizations are different circular polarizations.

In a sixth embodiment of the second solution, the first of the two quantization schemes is associated with all reported PMIs, conditioned that the total number of reported PMI segments being no larger than a threshold value δ, and a second of the two quantization schemes is associated with all reported PMIs, conditioned that the total number of reported PMI segments being larger than a threshold value δ. In one example, δ=2. In other words, a UE may be configured with two quantization schemes, with one scheme being selected for all PMI segments based on the overall number of TRPs for which CSI is reported.

In a seventh embodiment of the second solution, the first of the two quantization schemes is associated with all reported PMIs, conditioned that the total number of layers reported across all PMI segments being no larger than a threshold value λ, and a second of the two quantization schemes is associated with all reported PMIs, conditioned that the total number of layers reported across all PMI segments being larger than a threshold value λ. In one example, λ=4. In other words, a UE may be configured with two quantization schemes, with one scheme being selected for all PMI segments based on the overall number of PMI layers being reported.

Embodiments of the third solution relate to a configured maximum number of non-zero coefficients (“NNZC”) corresponding to the two groups of PMI segments. A CSI report corresponding to CJT comprises multiple PMI segments that are associated with two groups of PMI segments, wherein a maximum NNZC corresponding to the multiple PMI segments is configured or set by a rule. This embodiment set addresses introducing a limitation on a maximum NNZC per group of PMI segments, in addition to the limitation on the maximum NNZC corresponding to the multiple PMI segments, as follows:

In a first embodiment, the maximum NNZC corresponding to the first group of PMI segments has a same or higher value of the maximum NNZC corresponding to the second group of PMI segments. Accordingly, in this embodiment, the configured maximum NNZC of the first PMI group is greater than or equal to the configured maximum NNZC of the second PMI group.

In a second embodiment, the first group of PMI segments comprises one PMI segment corresponding to a strongest PMI, and the second group of PMI segments comprises one or more PMI segments, wherein the maximum NNZC corresponding to the PMI segment of the first group of PMI segments has a same value of a summation of a maximum NNZC corresponding to the one or more PMI segments of the second group of PMI segments. Accordingly, in this embodiment, the configured maximum NNZC of the strongest PMI group is equal to the sum of the configured maximum NNZC(s) of the remainder PMI(s).

Regarding Antenna Panel/Port, Quasi-co-location (“QCL”), TCI state, and Spatial Relation, in some embodiments, the terms antenna, panel, and antenna panel are used interchangeably. An antenna panel may be a hardware that is used for transmitting and/or receiving radio signals at frequencies lower than 6 GHz, e.g., frequency range 1 (“FR1”), or higher than 6 GHz, e.g., frequency range 2 (“FR2”) or millimeter wave (mmWave). In some embodiments, an antenna panel may comprise an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some embodiments, an antenna panel may or may not be virtualized as an antenna port in the specifications. An antenna panel may be connected to a baseband processing module through a radio frequency (“RF”) chain for each of transmission (egress) and reception (ingress) directions. The capability of a device in terms of the number of antenna panels, their duplexing capabilities, their beamforming capabilities, and so on, may or may not be transparent to other devices. In some embodiments, capability information may be communicated via signaling or, in some embodiments, capability information may be provided to devices without a need for signaling. In the case that such information is available to other devices, it can be used for signaling or local decision making.

In some embodiments, a device (e.g., UE, node) antenna panel may be a physical or logical antenna array comprising a set of antenna elements or antenna ports that share a common or a significant portion of an RF chain (e.g., in-phase/quadrature (“I/Q”) modulator, analog to digital (“A/D”) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some embodiments, depending on device's own implementation, a “device panel” can have at least one of the following functionalities as an operational role of Unit of antenna group to control its transmit (“Tx”) beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or comprise a duration of time over which the gNB assumes there will be no change to the mapping. A device may report its capability with respect to the “device panel” to the gNB or network. The device capability may include at least the number of “device panels.” In one implementation, the device may support UL transmission from one beam within a panel; with multiple panels, more than one beam (one beam per panel) may be used for UL transmission. In another implementation, more than one beam per panel may be supported/used for UL transmission.

In some of the embodiments described, an antenna port is defined such that the channel over which a symbol on the antenna port is conveyed can be inferred from the channel over which another symbol on the same antenna port is conveyed.

Two antenna ports are said to be quasi-co-located (“QCL'd”) if the large-scale properties of the channel over which a symbol on one antenna port is conveyed can be inferred from the channel over which a symbol on the other antenna port is conveyed. The large-scale properties include one or more of: delay spread, Doppler spread, Doppler shift, average gain, average delay, and spatial receive (“Rx”) parameters. Two antenna ports may be QCL'd with respect to a subset of the large-scale properties and different subset of large-scale properties may be indicated by a QCL Type parameter.

The QCL Type parameter can indicate which channel properties are the same between the two reference signals (e.g., on the two antenna ports). Thus, the reference signals can be linked to each other with respect to what the UE can assume about their channel statistics or QCL properties. For example, parameter qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Spatial Rx parameters may include one or more of: angle of arrival (“AoA”), Dominant AoA, average AoA, angular spread, Power Angular Spectrum (“PAS”) of AoA, average angle of departure (“AoD”), PAS of AoD, transmit/receive channel correlation, transmit/receive beamforming, spatial channel correlation etc.

The values QCL-TypeA, QCL-TypeB, and QCL-TypeC may be applicable for all carrier frequencies, but the value QCL-TypeD may be applicable only in higher carrier frequencies (e.g., mmWave, FR2 and beyond), where essentially the UE may not be able to perform omni-directional transmission, i.e., the UE would need to form beams for directional transmission. A QCL-TypeD parameter between two reference signals A and B, the reference signal A is considered to be spatially co-located with reference signal B and the UE may assume that the reference signals A and B can be received with the same spatial filter (e.g., with the same Rx beamforming weights).

An “antenna port” according to an embodiment may be a logical port that may correspond to a beam (resulting from beamforming) or may correspond to a physical antenna on a device. In some embodiments, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (“CDD”). The procedure used to derive antenna ports from physical antennas may be specific to a device implementation and transparent to other devices.

In some of the embodiments described, a Transmission Configuration Indication (“TCI”) state associated with a target transmission can indicate parameters for configuring a QCL relationship between the target transmission (e.g., target Reference Signal (“RS”) of Demodulation Reference Signal (“DM-RS”) ports of the target transmission during a transmission occasion) and a source reference signal(s) (e.g., Synchronization Signal Block (“SSB”), CSI-RS, and/or Sounding Reference Signal (“SRS”)) with respect to quasi co-location type parameter(s) indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the embodiments described, a TCI state comprises at least one source reference signal (“RS”) to provide a reference (UE assumption) for determining QCL and/or spatial filter.

In some of the embodiments described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

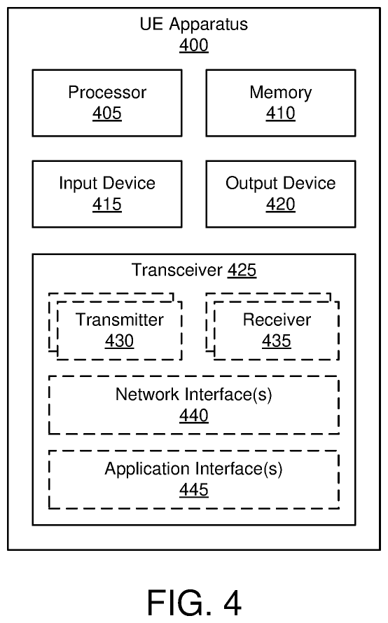

FIG. 4 illustrates an example of a UE apparatus 400 that may be used for coefficient quantization for CSI feedback under CJT, in accordance with aspects of the present disclosure. In various embodiments, the UE apparatus 400 is used to implement one or more of the solutions described above. The UE apparatus 400 may be an example of a communication device, such as the remote unit 105 and/or the UE 205, as described above. Furthermore, the UE apparatus 400 may include a processor 405, a memory 410, an input device 415, an output device 420, and a transceiver 425.

In some embodiments, the input device 415 and the output device 420 are combined into a single device, such as a touchscreen. In certain embodiments, the UE apparatus 400 may not include any input device 415 and/or output device 420. In various embodiments, the UE apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. In some embodiments, the transceiver 425 communicates with one or more cells (or wireless coverage areas) supported by one or more base station units 121. In various embodiments, the transceiver 425 is operable on unlicensed spectrum. Moreover, the transceiver 425 may include multiple UE panels supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425.

In various embodiments, the processor 405 controls the UE apparatus 400 to implement the above-described UE behaviors. In certain embodiments, the processor 405 may include an application processor (also known as “main processor”) which manages application-domain and operating system (“OS”) functions and a baseband processor (also known as “baseband radio processor”) which manages radio functions.

In various embodiments, the transceiver 425 is configured to communicate with an access network (e.g., a NG-RAN). Via the transceiver 425, the processor 405 receives, e.g., from a RAN, a CSI reporting setting that is associated with a CMR corresponding to at least two CSI-RS segments, where the at least two CSI-RS segments (e.g., CSI-RS units) correspond to at least two PMI segments, and receives a set of CSI-RS on the CMR. The processor 405 generates at least two sets of (i.e., one or more) coefficients based on the at least two CSI-RS segments. Each PMI segment contains a set of coefficients, each coefficient associated with at least one of a quantized amplitude value and a quantized phase value according to one of at least two quantization schemes.

To generate the at least two sets of coefficients, the processor is configured to cause the apparatus to: quantize a first set of coefficients corresponding to a first of the at least two PMI segments according to a first of the at least two quantization schemes, and quantize a second set of coefficients corresponding to a second of the at least two PMI segments according to a second of the at least two quantization schemes. Via the transceiver 425, the processor 405 reports a CSI report comprising the at least two PMI segments. In various embodiments, the set of CSI-RS is received from a plurality of network nodes under coherent joint transmission to the UE. In such embodiments, the CSI report is transmitted to at least one network node of the plurality of network nodes.

In some embodiments, the set of CSI-RS is received under coherent joint transmission from a plurality of networks nodes, where each of the at least two PMI segments corresponds to a different one of the plurality of network nodes, and where the CSI report is transmitted to at least one network node of the plurality of network nodes. In certain embodiments, each network node of the plurality of network nodes is associated with a distinct TCI state of a PDSCH transmission. In some embodiments, each of the at least two CSI-RS segments corresponds to a distinct NZP CSI-RS resource.

In some embodiments, a first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. In certain embodiments, the first subset of the set of CSI-RS ports corresponds to a first CDM group, and the second subset of the set of CSI-RS ports corresponds to a second CDM group.

In some embodiments, the at least two PMI segments correspond to at least two PMI quantities (e.g., PMI values/codewords). In some embodiments, the at least two PMI segments correspond to at least two sets of NZP CSI-RS ports of the same PMI quantity (e.g., same PMI value). In some embodiments, the at least two PMI segments correspond to at least two sets of beams of the same PMI quantity (e.g., same PMI value).

In some embodiments, the CSI report comprises an indication of a strongest PMI segment of the at least two PMI segments. In certain embodiments, the first set of coefficients quantized with the first quantization scheme correspond to the strongest PMI segment of the at least two PMI segments, and the second set of coefficients quantized with the second quantization scheme corresponding to a remainder of PMI segments of the at least two PMI segments.

In certain embodiments, a first configured maximum number of non-zero coefficients corresponding to the strongest PMI segment is larger than each second configured maximum number of non-zero coefficients corresponding to a remainder of PMI segments of the at least two PMI segments. In further embodiments, the configured maximum number of non-zero coefficients corresponding to the strongest PMI segment is equal to a summation of the second configured maximum numbers of non-zero coefficients corresponding to the remainder of PMI segments.

In some embodiments, the first quantization scheme corresponds to a first codebook of phase values and the second quantization scheme corresponds to a second codebook of phase values, where the first codebook comprises a larger number of phase values than the second codebook. In some embodiments, the first quantization scheme corresponds to a first codebook of amplitude values and the second quantization scheme corresponds to a second codebook of amplitude values, where the first codebook comprises a larger number of amplitude values than the second codebook.

In some embodiments, the processor 405 generates a reference amplitude value that is common for a subset of the set of coefficients of the first of the at least two PMI segments, where the subset of the set of coefficients corresponds to one of two equal-sized groups of indices of one dimension of the first PMI segment. In certain embodiments, the first quantization scheme comprises a codebook of reference amplitude values corresponding to the generated reference amplitude value of the first PMI segment, where the second quantization scheme does not comprise a codebook of reference amplitude values.

In some embodiments, the first set of coefficients is empty (i.e., all coefficients are quantized according to the second quantization scheme) when the total number of PMI segments reported in the CSI report is larger than a threshold value. In certain embodiments, the threshold value of PMI segments is two. In some embodiments, the first set of coefficients is empty when the aggregate number of layers reported in the at least two PMI segments reported in the CSI report is larger than the threshold value. In certain embodiments, the threshold value of layers reported is four.

In some embodiments, the second set of coefficients is empty (i.e., all coefficients are quantized according to the first quantization scheme) when a total number of PMI segments reported in the CSI report is not larger than a threshold value. In certain embodiments, the threshold value of PMI segments is two. In some embodiments, the second set of coefficients is empty when an aggregate number of layers reported in the at least two PMI segments reported in the CSI report is not larger than a threshold value. In certain embodiments, the threshold value of layers reported is four.

The memory 410, in one embodiment, is a computer readable storage medium. In some embodiments, the memory 410 includes volatile computer storage media. For example, the memory 410 may include a random-access memory (“RAM”), including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to coefficient quantization for CSI feedback under CJT and/or mobile operation. For example, the memory 410 may store parameters, configurations, and the like as described above. In certain embodiments, the memory 410 also stores program code and related data, such as an operating system or other controller algorithms operating on the UE apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 420 may include a wearable display separate from, but communicatively coupled to, the rest of the UE apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least one transmitter 430 and at least one receiver 435. One or more transmitters 430 may be used to provide UL communication signals to a base station unit 121, such as the UL transmissions described herein. Similarly, one or more receivers 435 may be used to receive DL communication signals from the base station unit 121, as described herein. Although only one transmitter 430 and one receiver 435 are illustrated, the UE apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one or more common control signals or as modular transmitters 430 and receivers 435 implemented in the same hardware chip or in a multi-chip module.

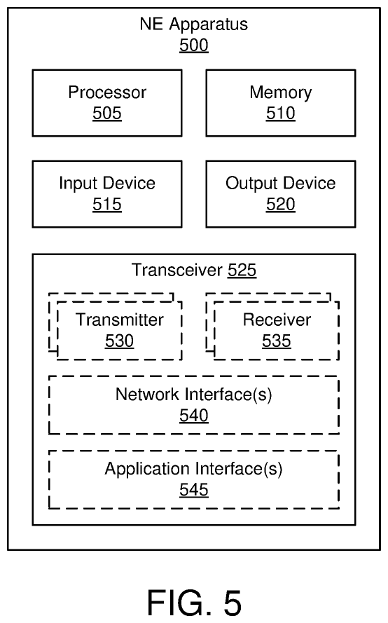

FIG. 5 illustrates an example of a NE apparatus 500 that may be used for coefficient quantization for CSI feedback under CJT, in accordance with aspects of the present disclosure. In one embodiment, the NE apparatus 500 may be one implementation of a network endpoint, such as a base station unit 121, the RAN node 210, the TRP-1 303, the TRP-2 305, the TRP-3 307, and/or the TRP-4 309, as described above. Furthermore, the NE apparatus 500 may include a processor 505, a memory 510, an input device 515, an output device 520, and a transceiver 525.

In some embodiments, the input device 515 and the output device 520 are combined into a single device, such as a touchscreen. In certain embodiments, the NE apparatus 500 may not include any input device 515 and/or output device 520. In various embodiments, the NE apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the NE apparatus 500 is a RAN node (e.g., gNB) that communicates with one or more UEs and one or more NFs, as described herein. In such embodiments, the processor 505 controls the NE apparatus 500 to perform the above-described RAN behaviors. When operating as a RAN node, the processor 505 may include an application processor (also known as “main processor”) which manages application-domain and operating system (“OS”) functions and a baseband processor (also known as “baseband radio processor”) which manages radio functions.

In various embodiments, the transceiver 525 is configured to communicate with a UE. Note that the processor 505 and transceiver 525 may communicate with the UE via a network interface 540, such as the Uu interface as defined by 3GPP. Via the transceiver 525, the processor 505 transmits, to the UE, a CSI reporting setting that is associated with a CMR corresponding to at least two CSI-RS segments (i.e., CSI-RS units), where the at least two CSI-RS segments correspond to at least two PMI segments, and transmits a set of CSI-RS on the CMR. Via the transceiver 525, the processor 505 receives a CSI report containing the at least two PMI segments, where each PMI segment contains a set of coefficients based on a corresponding CSI-RS segment and each coefficient associated with at least one of a quantized amplitude value and a quantized phase value according to one of at least two quantization schemes. Here, a first of the at least two PMI segments corresponds to a first set of coefficients that is quantized according to a first of the at least two quantization schemes, and a second of the at least two PMI segments corresponds to a second set of coefficients that is quantized according to a second of the at least two quantization schemes.

In some embodiments, each of the at least two CSI-RS segments corresponds to a distinct NZP CSI-RS resource. In some embodiments, a first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. In certain embodiments, the first subset of the set of CSI-RS ports corresponds to a first CDM group, and the second subset of the set of CSI-RS ports corresponds to a second CDM group.

In some embodiments, the at least two PMI segments correspond to at least two PMI quantities (e.g., PMI values/codewords). In some embodiments, the at least two PMI segments correspond to at least two sets of NZP CSI-RS ports of the same PMI quantity (e.g., same PMI value). In some embodiments, the at least two PMI segments correspond to at least two sets of beams of the same PMI quantity (e.g., same PMI value).

In some embodiments, the CSI report comprises an indication of a strongest PMI segment of the at least two PMI segments. In certain embodiments, the first set of coefficients quantized with the first quantization scheme correspond to the strongest PMI segment of the at least two PMI segments, and the second set of coefficients quantized with the second quantization scheme corresponding to a remainder of PMI segments of the at least two PMI segments.

In certain embodiments, the processor 505 configures the UE with a maximum number of non-zero coefficients corresponding to each PMI segment. Here, a first configured maximum number of non-zero coefficients corresponding to the strongest PMI segment is larger than each second configured maximum number of non-zero coefficients corresponding to a remainder of PMI segments of the at least two PMI segments. In further embodiments, the first configured maximum number of non-zero coefficients corresponding to the strongest PMI segment is equal to a summation of the second configured maximum number of non-zero coefficients corresponding to the remainder of PMI segments.

In some embodiments, the first quantization scheme corresponds to a first codebook of phase values and the second quantization scheme corresponds to a second codebook of phase values, where the first codebook comprises a larger number of phase values than the second codebook. In some embodiments, the first quantization scheme corresponds to a first codebook of amplitude values and the second quantization scheme corresponds to a second codebook of amplitude values, where the first codebook comprises a larger number of amplitude values than the second codebook.

The memory 510, in one embodiment, is a computer readable storage medium. In some embodiments, the memory 510 includes volatile computer storage media. For example, the memory 510 may include a RAM, including DRAM, SDRAM, and/or SRAM. In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to coefficient quantization for CSI feedback under CJT. For example, the memory 510 may store parameters, configurations, and the like, as described above. In certain embodiments, the memory 510 also stores program code and related data, such as an operating system or other controller algorithms operating on the NE apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the NE apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 includes at least one transmitter 530 and at least one receiver 535. One or more transmitters 530 may be used to communicate with the UE, as described herein. Similarly, one or more receivers 535 may be used to communicate with network functions in the PLMN and/or RAN, as described herein. Although only one transmitter 530 and one receiver 535 are illustrated, the NE apparatus 500 may have any suitable number of transmitters 530 and receivers 535. Further, the transmitter(s) 530 and the receiver(s) 535 may be any suitable type of transmitters and receivers.

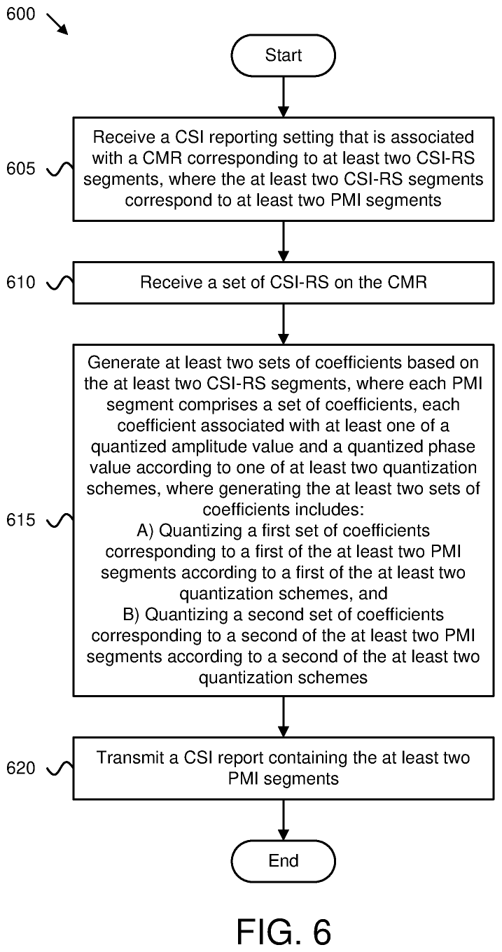

FIG. 6 illustrates a flowchart of a method 600 for coefficient quantization for CSI feedback under CJT, in accordance with aspects of the present disclosure. The operations of the method 600 may be implemented by a communication device, such as the remote unit 105, the UE 205, and/or the UE apparatus 400 (or components thereof), as described herein. Additionally, or alternatively, the operations of the method 600 may be performed by a processor executing program code, for example, a microcontroller, a microprocessor, a CPU, a GPU, an auxiliary processing unit, a FPGA, or the like.

The method 600 begins and receives 605, from a RAN, a CSI reporting setting that is associated with a CMR corresponding to at least two CSI-RS segments, where the at least two CSI-RS segments correspond to at least two PMI segments. The method 600 includes receiving 610 a set of CSI reference signals. Here, the set of CSI reference signals may be received from a plurality of RAN nodes under coherent joint transmission to the UE.

The method 600 includes generating 615 at least two sets of coefficients based on the at least two CSI-RS segments, where each PMI segment comprises a set of coefficients, each coefficient associated with at least one of a quantized amplitude value and a quantized phase value according to one of at least two quantization schemes, where generating the at least two sets of coefficients includes: A) Quantizing a first set of coefficients corresponding to a first of the at least two PMI segments according to a first of the at least two quantization schemes, and B) Quantizing a second set of coefficients corresponding to a second of the at least two PMI segments according to a second of the at least two quantization schemes.

The method 600 includes transmitting 620 a CSI report that contains the at least two PMI segments. Here, the CSI report is transmitted to at least one of the plurality of network nodes. The method 600 ends.

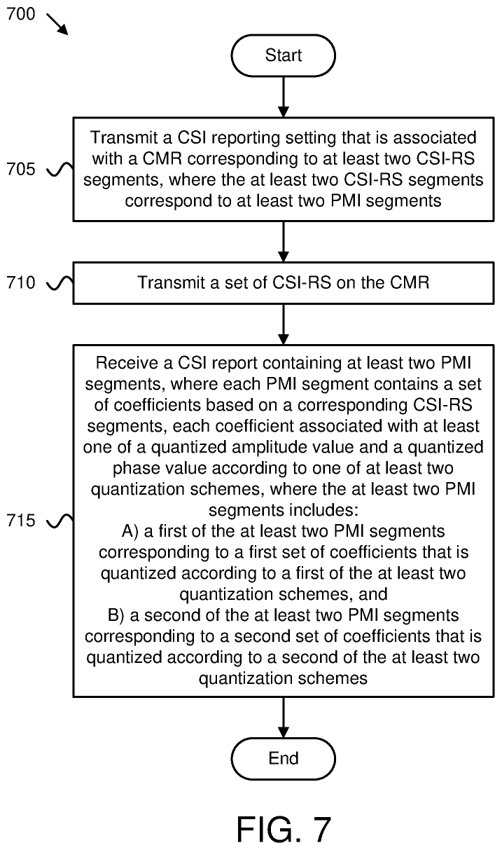

FIG. 7 illustrates a flowchart of a method 700 for coefficient quantization for CSI feedback under CJT, in accordance with aspects of the present disclosure. The operations of the method 700 may be implemented by a network entity, such as a base station unit 121, the RAN node 210, the TRP-1 303, the TRP-2 305, the TRP-3 307, the TRP-4 309, and/or the NE apparatus 500 (or components thereof), as described herein. Additionally, or alternatively, the operations of the method 700 may be performed by a processor executing program code, for example, a microcontroller, a microprocessor, a CPU, a GPU, an auxiliary processing unit, a FPGA, or the like.

The method 700 begins and transmits 705, to a UE, a CSI reporting setting that is associated with a CMR corresponding to at least two CSI-RS segments, where the at least two CSI-RS segments correspond to at least two PMI segments. The method 700 includes transmitting 710 a set of CSI reference signals.

The method 700 includes receiving 715 a CSI report containing at least two PMI segments, where each PMI segment contains a set of coefficients based on a corresponding CSI-RS segments, each coefficient associated with at least one of a quantized amplitude value and a quantized phase value according to one of at least two quantization schemes, where the at least two PMI segments includes: A) a first of the at least two PMI segments corresponding to a first set of coefficients that is quantized according to a first of the at least two quantization schemes, and B) a second of the at least two PMI segments corresponding to a second set of coefficients that is quantized according to a second of the at least two quantization schemes. The method 700 ends.

Disclosed herein is a first apparatus for coefficient quantization for CSI feedback under CJT, in accordance with aspects of the present disclosure. The first apparatus may be implemented by a communication device, such as the remote unit 105, the UE 205, and/or the UE apparatus 400, as described above. The first apparatus includes a processor coupled to a memory storing instructions executable by the processor to cause the first apparatus to: A) receive a CSI reporting setting that is associated with a CMR corresponding to at least two CSI-RS segments, where the at least two CSI-RS segments correspond to at least two PMI segments; B) receive a set of CSI-RS on the CMR; C) generate at least two sets of coefficients based on the at least two CSI-RS segments; and D) report a CSI report comprising the at least two PMI segments. Each PMI segment contains a set of coefficients, each coefficient associated with at least one of a quantized amplitude value and a quantized phase value according to one of at least two quantization schemes. To generate the at least two sets of coefficients, the processor is configured to cause the apparatus to: quantize a first set of coefficients corresponding to a first of the at least two PMI segments according to a first of the at least two quantization schemes, and quantize a second set of coefficients corresponding to a second of the at least two PMI segments according to a second of the at least two quantization schemes.

In some embodiments, the set of CSI-RS is received under coherent joint transmission from a plurality of networks nodes, where each of the at least two PMI segments corresponds to a different one of the plurality of network nodes, and where the CSI report is transmitted to at least one network node of the plurality of network nodes. In certain embodiments, each network node of the plurality of network nodes is associated with a distinct TCI state of a PDSCH transmission. In some embodiments, each of the at least two CSI-RS segments corresponds to a distinct NZP CSI-RS resource.

In some embodiments, a first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. In certain embodiments, the first subset of the set of CSI-RS ports corresponds to a first CDM group, and the second subset of the set of CSI-RS ports corresponds to a second CDM group.

In some embodiments, the at least two PMI segments correspond to at least two PMI quantities. In some embodiments, the at least two PMI segments correspond to at least two sets of NZP CSI-RS ports of the same PMI quantity. In some embodiments, the at least two PMI segments correspond to at least two sets of beams of the same PMI quantity.

In some embodiments, the CSI report comprises an indication of a strongest PMI segment of the at least two PMI segments. In certain embodiments, the first set of coefficients quantized with the first quantization scheme correspond to the strongest PMI segment of the at least two PMI segments, and the second set of coefficients quantized with the second quantization scheme corresponding to a remainder of PMI segments of the at least two PMI segments.

In certain embodiments, a first configured maximum number of non-zero coefficients corresponding to the strongest PMI segment is larger than each second configured maximum number of non-zero coefficients corresponding to a remainder of PMI segments of the at least two PMI segments. In further embodiments, the configured maximum number of non-zero coefficients corresponding to the strongest PMI segment is equal to a summation of the second configured maximum numbers of non-zero coefficients corresponding to the remainder of PMI segments.

In some embodiments, the first quantization scheme corresponds to a first codebook of phase values and the second quantization scheme corresponds to a second codebook of phase values, where the first codebook comprises a larger number of phase values than the second codebook. In some embodiments, the first quantization scheme corresponds to a first codebook of amplitude values and the second quantization scheme corresponds to a second codebook of amplitude values, where the first codebook comprises a larger number of amplitude values than the second codebook.

In some embodiments, the processor is configured to cause the apparatus to generate a reference amplitude value that is common for a subset of the set of coefficients of the first of the at least two PMI segments, where the subset of the set of coefficients corresponds to one of two equal-sized groups of indices of one dimension of the first PMI segment. In certain embodiments, the first quantization scheme comprises a codebook of reference amplitude values corresponding to the generated reference amplitude value of the first PMI segment, where the second quantization scheme does not comprise a codebook of reference amplitude values.

In some embodiments, the first set of coefficients is empty (i.e., all coefficients are quantized according to the second quantization scheme) when the total number of PMI segments reported in the CSI report is larger than a threshold value. In certain embodiments, the threshold value of PMI segments is two. In some embodiments, the first set of coefficients is empty when the aggregate number of layers reported in the at least two PMI segments reported in the CSI report is larger than the threshold value. In certain embodiments, the threshold value of layers reported is four.

In some embodiments, the second set of coefficients is empty (i.e., all coefficients are quantized according to the first quantization scheme) when a total number of PMI segments reported in the CSI report is not larger than a threshold value. In certain embodiments, the threshold value of PMI segments is two. In some embodiments, the second set of coefficients is empty when an aggregate number of layers reported in the at least two PMI segments reported in the CSI report is not larger than a threshold value. In certain embodiments, the threshold value of layers reported is four.

Disclosed herein is a first method for coefficient quantization for CSI feedback under CJT, in accordance with aspects of the present disclosure. The first method may be performed by a communication device, such as the remote unit 105, the UE 205, and/or the UE apparatus 400, as described above. The first method includes the first method includes receiving a CSI reporting setting that is associated with a CMR corresponding to at least two CSI-RS segments, where the at least two CSI-RS segments correspond to at least two PMI segments. The first method includes receiving a set of CSI-RS on the CMR and generating at least two sets of coefficients based on the at least two CSI-RS segments, where each PMI segment comprises a set of coefficients, each coefficient associated with at least one of a quantized amplitude value and a quantized phase value according to one of at least two quantization schemes. Here, generating the at least two sets of coefficients includes quantizing a first set of coefficients corresponding to a first of the at least two PMI segments according to a first of the at least two quantization schemes and quantizing a second set of coefficients corresponding to a second of the at least two PMI segments according to a second of the at least two quantization schemes. The first method includes transmitting a CSI report comprising the at least two PMI segments.

In some embodiments, the set of CSI-RS is received under coherent joint transmission from a plurality of networks nodes, where each of the at least two PMI segments corresponds to a different one of the plurality of nodes, and where the CSI report is transmitted to at least one network node of the plurality of network nodes. In certain embodiments, each network node of the plurality of network nodes is associated with a distinct TCI state of a PDSCH transmission.

In some embodiments, each of the at least two CSI-RS segments corresponds to a distinct NZP CSI-RS resource. In some embodiments, a first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. In certain embodiments, the first subset of the set of CSI-RS ports corresponds to a first code-division multiplexing (“CDM”) group, and the second subset of the set of CSI-RS ports corresponds to a second CDM group.

In some embodiments, the at least two PMI segments correspond to at least two PMI quantities. In some embodiments, the at least two PMI segments correspond to at least two sets of NZP CSI-RS ports of the same PMI quantity. In some embodiments, the at least two PMI segments correspond to at least two sets of beams of the same PMI quantity.

In some embodiments, the CSI report comprises an indication of a strongest PMI segment of the at least two PMI segments. In certain embodiments, the first set of coefficients quantized with the first quantization scheme correspond to the strongest PMI segment of the at least two PMI segments, and the second set of coefficients quantized with the second quantization scheme corresponding to a remainder of PMI segments of the at least two PMI segments.

In certain embodiments, a first configured maximum number of non-zero coefficients corresponding to the strongest PMI segment is larger than each second configured maximum number of non-zero coefficients corresponding to a remainder of PMI segments of the at least two PMI segments. In further embodiments, the first configured maximum number of non-zero coefficients corresponding to the strongest PMI segment is equal to a summation of the second configured maximum numbers of non-zero coefficients corresponding to the remainder of PMI segments.

In some embodiments, the first quantization scheme corresponds to a first codebook of phase values, where the second quantization scheme corresponds to a second codebook of phase values, and where the first codebook comprises a larger number of phase values than the second codebook. In some embodiments, the first quantization scheme corresponds to a first codebook of amplitude values and the second quantization scheme corresponds to a second codebook of amplitude values, where the first codebook containing a larger number of amplitude values than the second codebook.

In some embodiments, the first method further includes generating a reference amplitude value that is common for a subset of the set of coefficients of the first of the at least two PMI segments, where the subset of the set of coefficients corresponds to one of two equal-sized groups of indices of one dimension of the first PMI segment. In certain embodiments, the first quantization scheme comprises a codebook of reference amplitude values corresponding to the generated reference amplitude value of the first PMI segment, where the second quantization scheme does not comprise a codebook of reference amplitude values.

In some embodiments, the second set of coefficients is empty (i.e., all coefficients are quantized according to the first quantization scheme) when a total number of PMI segments reported in the CSI report is not larger than a threshold value. In certain embodiments, the threshold value is two. In some embodiments, the second set of coefficients is empty when an aggregate number of layers reported in the at least two PMI segments reported in the CSI report is not larger than a threshold value. In certain embodiments, the threshold value is four.

In some embodiments, the first set of coefficients is empty (i.e., all coefficients are quantized according to the second quantization scheme) when the total number of PMI segments reported in the CSI report is larger than a threshold value. In certain embodiments, the threshold value is two. In some embodiments, the first set of coefficients is empty when the aggregate number of layers reported in the at least two PMI segments reported in the CSI report is larger than the threshold value. In certain embodiments, the threshold value is four.

Disclosed herein is a second apparatus for coefficient quantization for CSI feedback under CJT, in accordance with aspects of the present disclosure. The second apparatus may be implemented by a network entity, such as a base station unit 121, the RAN node 210, the TRP-1 303, the TRP-2 305, the TRP-3 307, the TRP-4 309, and/or the NE apparatus 500, as described above. The second apparatus includes a memory coupled to a processor, the memory including instructions executable by the processor to cause the second apparatus to: A) transmit, to a UE, a CSI reporting setting that is associated with a CMR corresponding to at least two CSI-RS segments, where the at least two CSI-RS segments correspond to at least two PMI segments; B) transmit a set of CSI-RS on the CMR; and C) receive a CSI report containing the at least two PMI segments, where each PMI segment contains a set of coefficients based on a corresponding CSI-RS segment and each coefficient associated with at least one of a quantized amplitude value and a quantized phase value according to one of at least two quantization schemes. Here, a first of the at least two PMI segments corresponds to a first set of coefficients that is quantized according to a first of the at least two quantization schemes, and a second of the at least two PMI segments corresponds to a second set of coefficients that is quantized according to a second of the at least two quantization schemes.

In some embodiments, each of the at least two CSI-RS segments corresponds to a distinct NZP CSI-RS resource. In some embodiments, a first CSI-RS segment of the at least two CSI-RS segments corresponds to a first subset of a set of CSI-RS ports of a NZP CSI-RS resource, and a second CSI-RS segment of the at least two CSI-RS segments corresponds to a second subset of the set of CSI-RS ports of the NZP CSI-RS resource. In certain embodiments, the first subset of the set of CSI-RS ports corresponds to a first CDM group, and the second subset of the set of CSI-RS ports corresponds to a second CDM group.

In some embodiments, the at least two PMI segments correspond to at least two PMI quantities (e.g., PMI values/codewords). In some embodiments, the at least two PMI segments correspond to at least two sets of NZP CSI-RS ports of the same PMI quantity (e.g., same PMI value). In some embodiments, the at least two PMI segments correspond to at least two sets of beams of the same PMI quantity (e.g., same PMI value).

In some embodiments, the CSI report comprises an indication of a strongest PMI segment of the at least two PMI segments. In certain embodiments, the first set of coefficients quantized with the first quantization scheme correspond to the strongest PMI segment of the at least two PMI segments, and the second set of coefficients quantized with the second quantization scheme corresponding to a remainder of PMI segments of the at least two PMI segments.

In certain embodiments, the processor is configured to cause the apparatus to configure a maximum number of non-zero coefficients corresponding to each PMI segment. Here, a first configured maximum number of non-zero coefficients corresponding to the strongest PMI segment is larger than each second configured maximum number of non-zero coefficients corresponding to a remainder of PMI segments of the at least two PMI segments. In further embodiments, the first configured maximum number of non-zero coefficients corresponding to the strongest PMI segment is equal to a summation of the second configured maximum number of non-zero coefficients corresponding to the remainder of PMI segments.

In some embodiments, the first quantization scheme corresponds to a first codebook of phase values and the second quantization scheme corresponds to a second codebook of phase values, where the first codebook comprises a larger number of phase values than the second codebook. In some embodiments, the first quantization scheme corresponds to a first codebook of amplitude values and the second quantization scheme corresponds to a second codebook of amplitude values, where the first codebook comprises a larger number of amplitude values than the second codebook.

Disclosed herein is a second method for coefficient quantization for CSI feedback under CJT, in accordance with aspects of the present disclosure. The second method may be performed by a network entity, such as a base station unit 121, the RAN node 210, the TRP-1 303, the TRP-2 305, the TRP-3 307, the TRP-4 309, and/or the NE apparatus 500, as described above. The second method includes transmitting, to a UE, a CSI reporting setting that is associated with a CMR corresponding to at least two CSI-RS segments, where the at least two CSI-RS segments correspond to at least two PMI segments. The second method includes transmitting a set of CSI-RS on the CMR and receiving a CSI report containing the at least two PMI segments, wherein each PMI segment contains a set of coefficients based on a corresponding CSI-RS segment, each coefficient associated with at least one of a quantized amplitude value and a quantized phase value according to one of at least two quantization schemes. Here, a first of the at least two PMI segments corresponds to a first set of coefficients that is quantized according to a first of the at least two quantization schemes and a second of the at least two PMI segments corresponds to a second set of coefficients that is quantized according to a second of the at least two quantization schemes.

In some embodiments, each of the at least two CSI-RS segments corresponds to a distinct NZP CSI-RS resource. In some embodiments, a first CSI-RS segment of the at least two CSI-RS segments corresponds to a first subset of a set of CSI-RS ports of a NZP CSI-RS resource, and wherein a second CSI-RS segment of the at least two CSI-RS segments corresponds to a second subset of the set of CSI-RS ports of the NZP CSI-RS resource. In certain embodiments, the first subset of the set of CSI-RS ports corresponds to a first CDM group, and the second subset of the set of CSI-RS ports corresponds to a second CDM group.

In some embodiments, the at least two PMI segments correspond to at least two PMI quantities. In some embodiments, the at least two PMI segments correspond to at least two sets of NZP CSI-RS ports of the same PMI quantity. In some embodiments, the at least two PMI segments correspond to at least two sets of beams of the same PMI quantity.

In some embodiments, the CSI report comprises an indication of a strongest PMI segment of the at least two PMI segments. In certain embodiments, the first set of coefficients quantized with the first quantization scheme correspond to the strongest PMI segment of the at least two PMI segments, and wherein the second set of coefficients quantized with the second quantization scheme corresponding to a remainder of PMI segments of the at least two PMI segments.

In certain embodiments, the second method further includes configuring a maximum number of non-zero coefficients corresponding to each PMI segment, wherein a first configured maximum number of non-zero coefficients corresponding to the strongest PMI segment is larger than each second configured maximum number of non-zero coefficients corresponding to a remainder of PMI segments of the at least two PMI segments. In further embodiments, the first configured maximum number of non-zero coefficients corresponding to the strongest PMI segment is equal to a summation of the second configured maximum number of non-zero coefficients corresponding to the remainder of PMI segments.

In some embodiments, the first quantization scheme corresponds to a first codebook of phase values and the second quantization scheme corresponds to a second codebook of phase values, where the first codebook comprises a larger number of phase values than the second codebook. In some embodiments, the first quantization scheme corresponds to a first codebook of amplitude values and the second quantization scheme corresponds to a second codebook of amplitude values, where the first codebook comprises a larger number of amplitude values than the second codebook.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a RAM, a read-only memory (“ROM”), an erasable programmable read-only memory (“EPROM”), an electronically erasable programmable read-only memory (“EEPROM”), a Flash memory, a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), WLAN, or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “at least one of A, B and C” includes only A, only B, only C, a combination of A and B, a combination of B and C, a combination of A and C or a combination of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described above with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. A user equipment (“UE”) for wireless communication, comprising:
a memory; and
a processor coupled with the memory and configured to cause the UE to:
receive a Channel State Information (“CSI”) reporting setting that is associated with a Channel Measurement Resource (“CMR”) corresponding to at least two CSI Reference Signal (“CSI-RS”) segments, wherein the at least two CSI-RS segments correspond to at least two Precoder Matrix Indicator (“PMI”) segments;
receive a set of CSI-RS on the CMR;
generate at least two sets of coefficients based on the at least two CSI-RS segments, wherein each PMI segment comprises a set of coefficients, each coefficient associated with at least one of a quantized amplitude value and a quantized phase value according to one of at least two quantization schemes,
wherein to generate the at least two sets of coefficients, the processor is configured to cause the UE to:
quantize a first set of coefficients corresponding to a first of the at least two PMI segments according to a first of the at least two quantization schemes, and
quantize a second set of coefficients corresponding to a second of the at least two PMI segments according to a second of the at least two quantization schemes; and
report a CSI report comprising the at least two PMI segments.

2. The UE of claim 1, wherein the set of CSI-RS is received under coherent joint transmission from a plurality of networks nodes, wherein each of the at least two PMI segments corresponds to a different one of the plurality of network nodes, and wherein the processor is configured to cause the UE to transmit the CSI report to at least one network node of the plurality of network nodes.

3. The UE of claim 1, wherein each of the at least two CSI-RS segments corresponds to a distinct non-zero power (“NZP”) CSI-RS resource.

4. The UE of claim 1, wherein the at least two PMI segments correspond to at least two PMI quantities.

5. The UE of claim 1, wherein the at least two PMI segments correspond to at least:
two sets of non-zero power (“NZP”) CSI-RS ports of a same PMI quantity;
two sets of beams of a same PMI quantity; or
a combination thereof.

6. The UE of claim 1, wherein the CSI report comprises an indication of a strongest PMI segment of the at least two PMI segments.

7. The UE of claim 6, wherein the first set of coefficients quantized with the first of the at least two quantization schemes correspond to the strongest PMI segment of the at least two PMI segments, and wherein the second set of coefficients quantized with the second of the at least two quantization schemes corresponding to a remainder of PMI segments of the at least two PMI segments.

8. The UE of claim 6, wherein a first configured maximum number of non-zero coefficients corresponding to the strongest PMI segment is larger than each second configured maximum number of non-zero coefficients corresponding to a remainder of PMI segments of the at least two PMI segments.

9. The UE of claim 1, wherein the first of the at least two quantization schemes corresponds to a first codebook of phase values and a first codebook of amplitude values, and the second of the at least two quantization schemes corresponds to a second codebook of phase values and a second codebook of amplitude values.

10. The UE of claim 1, wherein the processor is configured to cause the UE to generate a reference amplitude value that is common for a subset of the set of coefficients of the first of the at least two PMI segments, wherein the subset of the set of coefficients corresponds to one of two equal-sized groups of indices of one dimension of the first of the at least two PMI segments.

11. The UE of claim 10, wherein the first of the at least two quantization schemes comprises a codebook of reference amplitude values corresponding to a generated reference amplitude value of the first of the at least two PMI segments, and wherein the second of the at least two quantization schemes does not comprise a codebook of reference amplitude values.

12. The UE of claim 1, wherein the second set of coefficients is empty when a total number of PMI segments reported in the CSI report is not larger than a threshold value.

13. The UE of claim 1, wherein the second set of coefficients is empty when an aggregate number of transmission layers reported in the at least two PMI segments reported in the CSI report is not larger than a threshold value.

14. A method of a User Equipment (“UE”), the method comprising:
receiving a Channel State Information (“CSI”) reporting setting that is associated with a Channel Measurement Resource (“CMR”) corresponding to at least two CSI Reference Signal (“CSI-RS”) segments, wherein the at least two CSI-RS segments correspond to at least two Precoder Matrix Indicator (“PMI”) segments;
receiving a set of CSI-RS on the CMR;
generating at least two sets of coefficients based on the at least two CSI-RS segments, wherein each PMI segment comprises a set of coefficients, each coefficient associated with at least one of a quantized amplitude value and a quantized phase value according to one of at least two quantization schemes,
wherein generating the at least two sets of coefficients comprises:
quantizing a first set of coefficients corresponding to a first of the at least two PMI segments according to a first of the at least two quantization schemes, and
quantizing a second set of coefficients corresponding to a second of the at least two PMI segments according to a second of the at least two quantization schemes; and
transmitting a CSI report comprising the at least two PMI segments.

15. A base station for wireless communication, comprising:
a memory; and
a processor coupled with the memory and configured to cause the base station to:
transmit, to a User Equipment (“UE”), a Channel State Information (“CSI”) reporting setting that is associated with a Channel Measurement Resource (“CMR”) corresponding to at least two CSI Reference Signal (“CSI-RS”) segments, wherein the at least two CSI-RS segments correspond to at least two Precoder Matrix Indicator (“PMI”) segments;
transmit a set of CSI-RS on the CMR; and
receive a CSI report containing the at least two PMI segments, wherein each PMI segment contains a set of coefficients based on a corresponding CSI-RS segment, each coefficient associated with at least one of a quantized amplitude value and a quantized phase value according to one of at least two quantization schemes,
wherein a first of the at least two PMI segments corresponds to a first set of coefficients that is quantized according to a first of the at least two quantization schemes, and
wherein a second of the at least two PMI segments corresponds to a second set of coefficients that is quantized according to a second of the at least two quantization schemes.

16. The base station of claim 15, wherein the set of CSI-RS corresponds to a coherent joint transmission from a plurality of transmission-reception points (“TRPs”), wherein each of the at least two PMI segments corresponds to a different one of the plurality of TRPs.

17. The base station of claim 15, wherein each of the at least two CSI-RS segments corresponds to a distinct non-zero power (“NZP”) CSI-RS resource.

18. The base station of claim 15, wherein the at least two PMI segments correspond to at least two PMI quantities.

19. The base station of claim 15, wherein the at least two PMI segments correspond to at least:
two sets of non-zero power (“NZP”) CSI-RS ports of a same PMI quantity;
two sets of beams of a same PMI quantity; or
a combination thereof.

20. The UE of claim 9, wherein the first codebook of phase values comprises a number of values that is no less than a number of values of the second codebook of phase values, and the first codebook of amplitude values comprises a number of values that is no less than a number of values of the second codebook of amplitude values.
